(19) United States
(12) Patent Application Publication
(10) Pub. No.: US 2012/0183819 A1
(43) Pub. Date: Jul. 19, 2012

(54) BATTERY PACK, METHOD FOR MANUFACTURING BATTERY PACK, ELECTRONIC DEVICE, AND MOLDED PART

(75) Inventors: Takeru Yamamoto, Fukushima (JP); Toshinori Saito, Fukushima (JP); Sachio Akahira, Fukushima (JP)

(73) Assignee: SONY CORPORATION, Tokyo (JP)

(21) Appl. No.: 13/326,003

(22) Filed: Dec. 14, 2011

(30) Foreign Application Priority Data
Jan. 19, 2011 (JP) 2011-008930

(51) Int. Cl. H01M 2/02; H01M 10/04; H01M 2/10; H01M 10/42

(52) U.S. Cl. 429/61; 29/623.1; 429/97; 429/163

(57) ABSTRACT

A battery pack includes a battery and a casing covering the battery and formed of a shape-memory resin. A portion or the entirety of the casing is deformed by heating at a predetermined temperature. The deformed casing returns to an original shape at the predetermined temperature or higher.

### CROSS REFERENCES TO RELATED APPLICATIONS

The present application claims priority to Japanese Priority Patent Application JP 2011-008930 filed in the Japan Patent Office on Jan. 19, 2011, the entire content of which is hereby incorporated by reference.

### BACKGROUND

The present disclosure relates to, for example, battery packs having a molded part that changes shape at a predetermined temperature, methods for manufacturing such battery packs, and electronic devices.

Recently, various portable electronic devices such as camcorders, cellular phones, and laptop computers have been on the market, and the size and weight thereof are being reduced. Accordingly, there is a fast-growing demand for batteries used as power supplies for such portable electronic devices. To achieve a reduction in the size and weight of the devices, battery designs have been demanded that are lightweight, thin, and allow an efficient use of the accommodation space within the devices. The most suitable battery that meets the demand is a lithium-ion secondary battery, which has high energy density and power density.

A lithium-ion secondary battery includes a battery cell having positive and negative electrodes that can be doped and dedoped with lithium ions. This battery cell is sealed in a metal can or a metal laminated film and is controlled by a circuit board electrically connected to the battery cell.

Lithium-ion secondary batteries often have a mechanism for ensuring safety, such as a heat-sensing mechanism or a pressure-detecting mechanism. The safety mechanism is activated when the temperature detected by the heat-sensing mechanism or the pressure detected by the pressure-detecting mechanism exceeds a predetermined level.

Japanese Unexamined Patent Application Publication No. 2002-124224 (Patent Document 1), for example, discloses a battery pack having a heat-deformable member such as a bimetal or shape-memory alloy sheet. Japanese Patent No. 3638102 (Patent Document 2) discloses a battery pack having temperature fuses disposed at three or more positions, a strain sensor, a timer, and a data analyzer. Japanese Unexamined Patent Application Publication No. 2008-258110 (Patent Document 3) discloses a battery pack having a pressure detector between a housing and a battery cell to avoid a harmful effect due to deformation of the battery cell. Also proposed is the use of thermal paper as a heat-sensing mechanism.

In addition, there are some proposals to use a shape-memory polymer as a deformable member. For example, shape-memory polymers have found applications in form-fitting pillows, tableware, and tools. Japanese Patent No. 4390214 (Patent Document 4) discloses a shape-memory polymer designed for space applications. As an application of a shape-memory polymer to a battery, Japanese Unexamined Patent Application Publication No. 63-292568 (Patent Document 5) discloses the use of a shape-memory polymer as the material of a current-blocking mechanism. Japanese Unexamined Patent Application Publication No. 2009-151977 (Patent Document 6) discloses the use of a shape-memory polymer as a stress-generating material for bringing positive and negative electrodes into a closer contact to avoid increased resistance.

### SUMMARY

For example, the technique of using thermal paper to detect heat has a problem in that it only detects high temperature and does not stop the use of the battery pack. The technique of providing a temperature-detecting mechanism or a current-blocking mechanism, as disclosed in Patent Documents 1 to 3, uses a special part or increases the total number of parts. This technique is therefore disadvantageous in terms of cost and also has a problem in that it increases the volume of the parts other than the battery and therefore decreases the capacity of the battery pack. The techniques disclosed in Patent Documents 5 and 6 have the same problems.

In addition, casings of battery packs are typically formed of a metal such as aluminum or iron or a resin such as polypropylene or polycarbonate. If a battery pack having a metal casing such as an aluminum or iron casing heats up abnormally, it becomes hot because the casing has high thermal conductivity. It would therefore be preferable to release the hot battery pack from the device without letting the user touch it. The techniques disclosed in the above patent documents, however, have a problem in that they do not allow the battery pack to be released from the device.

In addition, the above resins, which melt and become liquid in the temperature range above 100° C., have a problem in that molten resin flows into a current-blocking part of an electronic device to make it conductive after it is activated.

It is therefore desirable to provide a molded part that changes shape so as to return to its original shape at a predetermined temperature and a battery pack, a method for manufacturing a battery pack, and an electronic device to which such a molded part is applied.

According to an embodiment of the present disclosure, there is provided a battery pack including a battery and a casing covering the battery and formed of a shape-memory resin. A portion or the entirety of the casing is deformed by heating at a predetermined temperature. The portion or the entirety of the deformed casing returns to an original shape at the predetermined temperature or higher.

According to another embodiment of the present disclosure, there is provided a method for manufacturing a battery pack. This method includes positioning a battery using a positioning portion, filling a space around the positioned battery with a shape-memory resin so as to form at least one protrusion, and deforming the protrusion by applying an external force to the protrusion in a heated state.

According to another embodiment of the present disclosure, there is provided an electronic device including a power supply and at least one molded part formed of a shape-memory resin. A portion or the entirety of the molded part is deformed by heating at a predetermined temperature. The portion or the entirety of the molded part returns to an original shape at the predetermined temperature or higher.

According to another embodiment of the present disclosure, there is provided a molded part formed of a shape-memory resin. The molded part is deformed by heating at a predetermined temperature. The deformed molded part is disposed near the power supply. The molded part returns to an original shape at the predetermined temperature or higher.

According to at least one embodiment, a molded part that changes shape at a predetermined temperature is provided. In addition, an electronic device, a battery pack, and a method for manufacturing a battery pack with improved reliability are provided.

Additional features and advantages are described herein, and will be apparent from the following Detailed Description and the figures.

### BRIEF DESCRIPTION OF THE FIGURES

FIGS. 1A and 1B are schematic views showing an example of deformation of a molded part;

FIGS. 2A and 2B are schematic views showing another example of deformation of a molded part;

FIGS. 3A and 3B are schematic views showing another example of deformation of a molded part;

FIGS. 4A and 4B are schematic views showing another example of deformation of a molded part;

FIGS. 5A and 5B are schematic views showing another example of deformation of a molded part;

FIGS. 6A and 6B are schematic views showing another example of deformation of a molded part;

FIG. 7 is a perspective view showing an example of the appearance of a battery pack;

FIG. 8 is a schematic view used for illustrating a step of covering a battery cell with a packaging film;

FIG. 9 is a perspective view used for illustrating the battery cell;

FIGS. 10A to 10C are schematic views for illustrating an example of a method for manufacturing a battery pack;

FIGS. 11A to 11D are schematic views for illustrating another example of a method for manufacturing a battery pack;

FIGS. 12A to 12C are schematic views for illustrating an application of a molded part to a notebook personal computer;

FIGS. 13A and 13B are schematic views for illustrating an application of molded parts to a shutter switch and a power supply lid of a digital camera;

FIGS. 14A and 14B are enlarged schematic views of the power supply lid of the digital camera;

FIGS. 15A to 15C are schematic views for illustrating an application of a molded part to a fitting portion of a hinge mechanism, showing its operation in normal use;

FIGS. 16A and 16B are schematic views for illustrating an application of a molded part to a fitting portion of a hinge mechanism, showing its operation at an abnormally high temperature;

FIGS. 17A and 17B are schematic views for illustrating an application of a molded part to a switch button for starting a cooling unit;

FIGS. 18A and 18B are schematic views for illustrating an application of a molded part to a switch button; and

FIGS. 19A and 19B are schematic views for illustrating an application of a molded part to a switch button.

### DETAILED DESCRIPTION

The present application will be described in detail below with reference to the figures according to an embodiment. As used herein, the symbol “%” for quantities such as density, content, and amount of material charged refers to mass percentage unless otherwise specified.

### Overview of Molded Part

An example of a molded part according to an embodiment of the present disclosure will now be outlined. The molded part is used as, for example, a casing of an electronic device, such as a digital video camera or a cellular phone, or a battery pack. The molded part is formed of, for example, a shape-memory resin, and deforms at a predetermined temperature. By deforming, the molded part operates as a safety mechanism for an electronic device or a battery pack.

The molded part is preferably formed of a reaction-curable resin such as a silicone, acrylic, epoxy, or urethane resin. In particular, a urethane resin is preferred in view of shock resistance upon dropping or impact and maximum yield stress. If the molded part is formed of a thermoplastic resin, which has a melting temperature of about 100° C. to 300° C., it melts in the temperature range where safety mechanisms for mobile electronic devices should operate.

The reaction-curable resin, such as a urethane resin, used in this embodiment is a shape-memory resin (shape-memory polymer). The shape-memory resin can be molded at a predetermined temperature or higher. As the resin is cooled after molding, the molded shape is fixed and memorized as its original shape. The shape-memory resin of the original shape can then be deformed into any shape by applying an external force while being heated to the predetermined temperature. After cooling, the deformed shape is maintained. The deformed molded part returns to its original shape when heated at the predetermined temperature or higher.

The phenomenon by which a polymeric material, when heated, changes from a glass-like hard state to a rubber-like state is called glass transition, and the temperature at which glass transition occurs is called the glass transition temperature, denoted as Tg. The above predetermined temperature is, for example, near the glass transition temperature.

The reaction-curable resin preferably has a glass transition temperature of 60° C. to 140° C. If the glass transition temperature falls below 60° C., a casing formed of the reaction-curable resin may deform partially, for example, inside a vehicle on a hot summer day, which may impair convenience for everyday use. If the glass transition temperature exceeds 140° C., on the other hand, the timing at which the resin deforms is delayed, thus making it difficult to ensure the safety and reliability of a power supply of an electronic device at an appropriate timing. Accordingly, the reaction-curable resin preferably has a glass transition temperature of 60° C. to 140° C.

More preferably, the reaction-curable resin has a glass transition temperature of 80° C. to 120° C. This allows the reaction-curable resin to function as a safety mechanism that, for example, blocks current, stops operation, starts a cooling mechanism, or releases a power supply before a resin part of a power supply, such as a separator of a battery, is affected.

Preferred as a resin having a glass transition temperature of 60° C. to 140° C., which is far higher than those of general-purpose resins, namely, about 0° C. to −40° C., is one having a higher cross-link density and containing a rigid group such as an aromatic, heterocyclic, or alicyclic group.

For example, the molded part preferably has a property change ratio of 1.1 to less than 10, where the property change ratio is given by the following equation: property change ratio of molded part after heating=elastic strain at softening temperature/elastic strain at room temperature. If the property change ratio is low, the heat-sensing mechanism may malfunction because of the insufficient change after heat deformation. On the other hand, if the property change ratio is excessively high, the molded part does not provide the advantage of maintaining its rubber elasticity without melting after heating, which is an advantage of this embodiment. This may cause the resin to flow, as does a thermoplastic resin, which decomposes and melts, thus causing a problem with an electronic part or a temperature rise. Accordingly, the property change ratio is preferably 1.1 to less than 10.

### Details of Molded Part

The details of the molded part will now be described. As described above, the molded part is formed of a reaction-curable resin such as a thermosetting resin, which cures by reacting with heat, or an ultraviolet-curable resin, which cures by reacting with ultraviolet radiation.

### Reaction-Curable Resin

The reaction-curable resin used is at least one resin selected from urethane, epoxy, acrylic, silicone, and dicyclopentadiene resins. Among them, at least one resin selected from urethane, epoxy, acrylic, and silicone resins is preferred, and a urethane resin is particularly preferred in view of shock resistance upon dropping or impact and maximum yield stress.

### Urethane Resin

A urethane resin is manufactured from a polyol and a polyisocyanate. The urethane resin used is preferably an insulating polyurethane resin, defined below. The term “insulating polyurethane resin” refers to a urethane resin that can form a cured material whose volume resistivity (Ω·cm) measured at 25±5° C. and 65±5% RH is 10¹⁰ Ω·cm or more. The insulating polyurethane resin used preferably has a dielectric constant of 6 or less (1 MHz) and a breakdown voltage of 15 kV/mm or more.

An insulating polyurethane resin can be prepared by adjusting, for example, the oxygen content of the polyol, the dissolved ion concentration, and the number of types of dissolved ions so that the resulting insulating cured material has a volume resistivity of 10¹⁰ Ω·cm or more, preferably 10¹¹ Ω·cm or more. In particular, if the volume resistivity is 10¹¹ Ω·cm or more, the cured material has excellent insulation properties, thus allowing a protection circuit board of a secondary battery to be sealed together. The volume resistivity is measured in accordance with JIS C2105, where a measurement voltage of 500 V is applied to a sample (3 mm thick) at 25±5° C. and 65±5% RH to measure the volume resistivity thereof after 60 seconds.

Examples of urethane resins include polyester urethanes, which are prepared using polyester polyols, polyether urethanes, which are prepared using polyether polyols, and urethane resins prepared using other polyols. These may be used alone or as a mixture of two or more. In addition, the polyol may contain a powder. Examples of powders include inorganic particles such as calcium carbonate, aluminum hydroxide, aluminum oxide, silicon oxide, titanium oxide, silicon carbide, silicon nitride, calcium silicate, magnesium silicate, and carbon particles; and organic polymer particles such as poly(methyl acrylate), poly(ethyl acrylate), poly(methyl methacrylate), poly(ethyl methacrylate), polyvinyl alcohol, carboxymethyl cellulose, polyurethane, and polyphenol particles. These can be used alone or as a mixture. The particles may be surface-treated, and polyurethane and polyphenol particles may be used as a foam powder. Other examples of powders used in this embodiment include porous particles.

### Polyol

### Polyester Polyol

A polyester polyol is a product of a fatty acid and a polyol. Examples of fatty acids include hydroxy-containing long-chain fatty acids such as ricinoleic acid, oxycapronic acid, oxycaprinic acid, oxyundecanoic acid, oxylinoleic acid, oxystearic acid, and oxyhexadecenoic acid.

Examples of polyols that react with fatty acids include glycols such as ethylene glycol, propylene glycol, butylene glycol, hexamethylene glycol, and diethylene glycol; trifunctional polyols such as glycerol, trimethylolpropane, and triethanolamine; tetrafunctional polyols such as diglycerol and pentaerythritol; hexafunctional polyols such as sorbitol; octafunctional polyols such as sugar; addition polymers of alkylene oxides corresponding to the above polyols with aliphatic, alicyclic, or aromatic amines; and addition polymers of the alkylene oxides with polyamide-polyamines. Particularly preferred are, for example, a glyceride of ricinoleic acid and a polyester polyol of ricinoleic acid and 1,1,1-trimethylolpropane.

### Polyether Polyol

Examples of polyether polyols include addition polymers of dihydric alcohols, such as ethylene glycol, diethylene glycol, propylene glycol, dipropylene glycol, 1,3-butanediol, 1,4-butanediol, 4,4′-dihydroxyphenylpropane, and 4,4′-dihydroxyphenylmethane, or trihydric or polyhydric alcohols, such as glycerol, 1,1,1-trimethylolpropane, 1,2,5-hexanetriol, and pentaerythritol, with alkylene oxides such as ethylene oxide, propylene oxide, butylene oxide, and α-olefin oxides.

### Other Polyols

Other polyols include polyols having a carbon-carbon main chain, such as acrylic polyols, polybutadiene polyols, polyisoprene polyols, and hydrogenated polybutadiene polyols; graft copolymers of the above carbon-carbon polyols with acrylonitrile (AN) or styrene monomer (SM); polycarbonate polyols; and polytetramethylene glycol (PTMG). For direct molding into battery packs, polyether polyols are preferred because they are highly capable of elastic recovery, have excellent chemical resistance, and are more cost-effective than carbonate polyols.

### Polyisocyanate

The polyisocyanate used can be, for example, an aromatic polyisocyanate, an aliphatic polyisocyanate, or an alicyclic polyisocyanate. Examples of aromatic polyisocyanates include diphenylmethane diisocyanate (MDI), polymethylene polyphenylene polyisocyanate (crude MDI), tolylene diisocyanate (TDI), polytolylene polyisocyanate (crude TDI), xylene diisocyanate (XDI), and naphthalene diisocyanate (NDI). Examples of aliphatic polyisocyanates include hexamethylene diisocyanate (HDI). Examples of alicyclic polyisocyanates include isophorone diisocyanate (IPDI). Other examples include the above polyisocyanates modified with carbodiimide (carbodiimide-modified polyisocyanates), isocyanurate-modified polyisocyanates, ethylene oxide-modified polyisocyanates, urethane prepolymers (for example, reaction products of polyols with excess polyisocyanate that have isocyanate groups at the molecular ends thereof). These may be used alone or as a mixture. Among them, diphenylmethane diisocyanate, polymethylene polyphenylene polyisocyanate, carbodiimide-modified polyisocyanates, and ethylene oxide-modified polyisocyanates are preferred.

The properties of the battery pack, such as heat resistance, flame retardancy, shock resistance, and moisture barrier properties, can be improved depending on the properties of the reaction-curable resin.

For example, if a urethane resin is used, it is preferable to use as a hard segment structure diphenylmethane diisocyanate (MDI), which is an isocyanate having the lowest molecular weight of those having a rigid benzene ring structure, and to adjust the weight mixing ratio (base/curing agent) of the polyol, serving as a base, and the isocyanate, serving as a curing agent, to 1 or less, preferably 0.7 or less. This provides a structure with high cross-link density having a rigid, symmetrical molecular chain, thus achieving excellent heat resistance and structural strength, improved flame retardancy due to urethane bonds, and resin viscosity appropriate for injection.

A higher diphenylmethane diisocyanate (MDI) content is advantageous in terms of strength and moisture barrier properties; however, an MDI content above 80% by weight results in a poor shock resistance due to an excessive amount of MDI hard segment structure. For higher weather resistance, a mixture of MDI with a non-yellowing polyisocyanate such as XDI, IPDI, or HDI is preferably used. To increase the cross-link density, a low-molecular-weight cross-linking agent such as trimethylolpropane is preferably added to the base.

The reaction-curable resin preferably has an impact strength, determined by the Izod V-notched impact test in accordance with JIS K7110, of 6 kJ/m² or more, more preferably 10 kJ/m² or more. If the impact strength is 6 kJ/m² or more, the resin exhibits excellent properties in a 1.9 m drop test and a 1 m drop test. If the impact strength is 10 kJ/m² or more, the resin exhibits particularly excellent properties in a drop test assumed to occur most probably on the market. As the molecular weight dispersity (number average molecular weight/weight average molecular weight) is increased, the fluidity and moldability of the resin improve, but the shock resistance tends to decrease. In view of fluidity, therefore, the viscosity is preferably at least 80 mPa·s. More preferably, the viscosity is adjusted within the range of 200 to 600 mPa·s so that the resin is easy to use.

The reaction-curable resin preferably has a flame retardancy equivalent to a burned area of 25 cm² or less in a UL 746C ¾ inch flame test using a specimen having a thickness of 0.05 to less than 0.4 mm.

If the reaction-curable resin used is a urethane resin, the polyol is preferably a flame-retardant polyol having the structure represented by formula (I):

PO(XR)₃ (1)

where R is hydrogen, alkyl, or phenyl, and X is sulfur, oxygen, nitrogen, or (CH₂)ₙ (n is an integer of 1 or more). Such a flame-retardant component in the structure of the urethane resin improves the flame retardancy, particularly if the resin is thin, and also ensures sufficient structural strength.

In cases where a urethane resin is not used, if the reaction-curable resin is thin, the shock resistance can be improved by lowering the glass transition temperature. This also improves the flame retardancy because the resin becomes substantially thicker and therefore more resistant to burning as it contracts with a flame of a burner. An extremely low or high glass transition temperature, however, tends to decrease strength and safety.

Accordingly, the reaction-curable resin preferably has a glass transition temperature of 60° C. to 140° C. and a melting (decomposition) temperature of 200° C. to 400° C. More preferably, the reaction-curable resin has a glass transition temperature of 80° C. to 120° C. and a melting (decomposition) temperature of 240° C. to 300° C. If the glass transition temperature falls below 60° C., it is difficult to ensure sufficient strength as a casing at an ambient temperature of 45° C. If the glass transition temperature exceeds 140° C., the release of energy accumulated in a battery due to abuse is delayed, which may cause an accident.

If the melting (decomposition) temperature is 200° C. to 400° C., with the glass transition temperature being 60° C. to 150° C., the flame retardancy is improved by the endothermic effect of melting or decomposition. A melting (decomposition) temperature below 200° C. does not contribute to improved flame retardancy because heat absorption occurs early in the promotion of carbonization and the formation of a heat-insulating layer. A melting (decomposition) temperature above 400° C. does not contribute to improved flame retardancy because the timing of heat absorption is delayed.

The reaction-curable resin preferably has a viscosity of 80 to less than 1,000 mPa·s. A viscosity within this range avoids a covering defect on the largest surface of the battery, thus avoiding a degradation in the properties of the battery pack. In addition, the reaction-curable resin has excellent fluidity because the time to curing is longer than that of a thermoplastic resin. However, a longer curing time results in a longer time during which the resin occupies the mold. This increases the number of molds and therefore increases manufacturing equipment cost and decreases productivity, which makes it difficult to increase volumetric energy density and decrease cost by reducing the thickness of the molded part of the battery pack. If the viscosity is insufficient, on the other hand, the reaction-curable resin exhibits excessively high fluidity, which may decrease manufacturing efficiency and increase defect rate because of flashing from a mold and resin flowing onto a board.

A reaction-curable resin (such as a urethane resin) has high adhesion to metals and can also adhere to a thermoplastic resin with its polar groups to form a rigid integrated structure. Although a polyamide resin, which is a thermoplastic resin, has some adhesion, the adhesion is insufficient to use it without physical adhesion strengthening and high charging pressure; a reaction-curable resin has no such constraint. Although the relationship between the adhesion and the aggregate structure of a urethane resin is unclear, there is a tendency to have a lower adhesion as its cross-link density is increased. Accordingly, it is preferable to use a bonding member having numerous active hydrogens on the surface thereof or numerous polar groups that easily form hydrogen bonds with the urethane resin.

Similarly, it is preferable to form an undercut on a portion to be fitted to a member to prevent separation from the member, or to roughen the surface of the member or make a cut thereon to increase the effective adhesion area. In addition, it is preferable to control the aggregate structure of the urethane resin depending on the temperature conditions during curing, for example, by lowering the temperature to increase the polar groups on the surface for increased adhesion or by raising the temperature to decrease the adhesion for control of mold releasability.

### Additive

The reaction-curable resin may contain additives such as a filler, a flame retardant, a defoaming agent, a bactericide, a stabilizer, a plasticizer, a thickener, a fungicide, and other resins.

Examples of flame retardants include triethyl phosphate and tris(2,3-dibromopropyl)phosphate. Other additives include fillers such as antimony trioxide and zeolite and colorants such as pigments and dyes.

### Catalyst

A catalyst may be added to the reaction-curable resin. The catalyst, which is added in order to facilitate the reaction between the isocyanate and the polyol and the dimerization or trimerization of the isocyanate, can be a catalyst used in the related art. Examples of catalysts include tertiary amines such as triethylenediamine, 2-methyltriethylenediamine, tetramethylhexanediamine, pentamethyldiethylenetriamine, pentamethyldipropylenetriamine, pentamethylhexanediamine, dimethylamino ethyl ether, trimethylaminopropylethanolamine, tridimethylaminopropylhexahydrotriazine, and tertiary ammonium salts.

A metal-based isocyanuration catalyst is preferably used in an amount of 0.5 to 20 parts by weight based on 100 parts by weight of the polyol. An amount of metal-based isocyanuration catalyst smaller than 0.5 part by weight is undesirable because it results in insufficient isocyanuration. On the other hand, an amount of metal-based isocyanuration catalyst larger than 20 parts by weight based on 100 parts by weight of the polyol does not provide an effect commensurate with the amount added.

Examples of metal-based isocyanuration catalysts include fatty acid metal salts such as dibutyltin dilaurate, lead octylate, potassium ricinoleate, sodium ricinoleate, potassium stearate, sodium stearate, potassium oleate, sodium oleate, potassium acetate, sodium acetate, potassium naphthenate, sodium naphthenate, potassium octylate, sodium octylate, and mixtures thereof.

Other catalysts include organotin compounds such as tri-n-butyltin acetate, n-butyltin trichloride, dimethyltin dichloride, dibutyltin dichloride, and trimethyltin hydroxide. These catalysts may be used directly or may be dissolved in a solvent such as ethyl acetate to a concentration of 0.1% to 20% and be added in an amount of 0.01 to 1 part by mass based on 100 parts by mass of the isocyanate in terms of solid content. Thus, the amount of catalyst added, either directly or as a solution, is preferably 0.01 to 1 part by mass based on 100 parts by mass of the isocyanate in terms of solid content, more preferably 0.05 to 0.5 part by mass. If the amount of catalyst added is insufficient, for example, less than 0.01 part, the polyurethane resin forms slowly and is difficult to mold because it does not cure to a hard resinous state. If the amount of catalyst added exceeds 1 part by mass, on the other hand, the resin forms extremely rapidly and is difficult to mold into a shape-retaining polymer layer.

### Metal Oxide Filler

The reaction-curable resin may contain a metal oxide filler. Examples of metal oxide fillers include silicon (Si), aluminum (Al), titanium (Ti), zirconium (Zr), zinc (Zn), and magnesium (Mg) oxides and mixtures thereof. The metal oxide filler functions to improve the hardness of the reaction-curable resin. The metal oxide filler is provided in contact with the layer containing the reaction-curable resin; for example, it may be mixed in the layer containing the reaction-curable resin. In this case, preferably, the metal oxide filler is evenly dispersed throughout the layer containing the reaction-curable resin.

The amount of metal oxide filler mixed can be changed depending on, for example, the type of polymer of the layer containing the reaction-curable resin. However, if the amount mixed falls below 3% of the mass of the layer containing the reaction-curable resin, it may insufficiently increase the hardness of the casing. If the amount mixed exceeds 60%, on the other hand, it may cause problems with moldability in manufacture and the brittleness of ceramic. Accordingly, the amount of metal oxide filler mixed is preferably about 2% to 50% of the mass of the layer containing the reaction-curable resin.

A metal oxide filler having a small average particle size provides high hardness, although it may cause a problem with productivity in terms of ease of filling in molding. A metal oxide filler having a large average particle size, on the other hand, may make it difficult to achieve the desired strength to ensure sufficient dimensional accuracy as the battery pack. Accordingly, the metal oxide filler preferably has an average particle size of 0.1 to 40 μm, more preferably 0.2 to 20 μm.

The metal oxide filler can have various shapes such as spheres, scales, flakes, and needles. Although any shape is permitted, a spherical filler is preferred in that it can be easily formed at low cost with uniform particle size, and a needle-like filler having a high aspect ratio is preferred in that the strength as a filler can be easily increased. In addition, a scale-like filler is preferred in that the ease of filling can be increased when the filler content is increased. It is also possible to use a mixture of fillers of different average particle sizes or of different shapes depending on the use and material.

In addition to metal oxides, the molded part can contain various additives. For example, the layer containing the reaction-curable resin can contain an ultraviolet absorber, a light stabilizer, a curing agent, or a mixture thereof together with a metal oxide filler.

### Examples of Deformation of Molded Part

The molded part, as described above, is deformed at a predetermined temperature. An example of the deformation of the molded part will now be described.

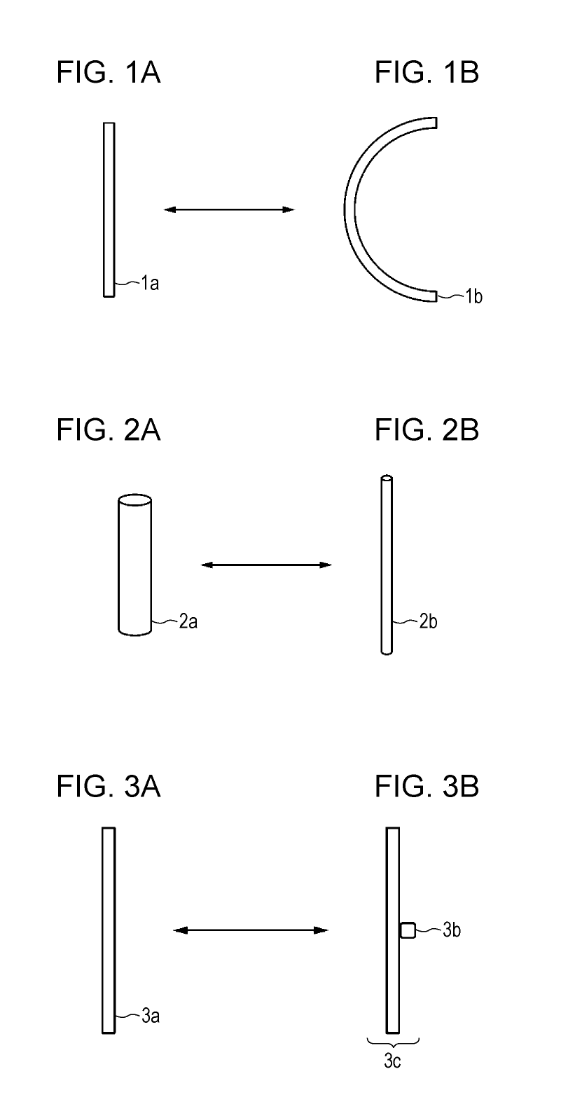

FIGS. 1A and 1B show an example of bending deformation of a molded part. FIG. 1A shows a molded part 1a, the shape of which is the original shape. For example, the rod shape as shown in FIG. 1A is the original shape. The molded part 1a is heated at a temperature near the glass transition temperature, and an external force is applied to the heated molded part 1a. As a result, the molded part 1a is deformed. For example, as shown in FIG. 1B, the molded part 1a is deformed into a curved shape. As the deformed molded part 1a is cooled, its curved shape is memorized. Thus, a molded part 1b is formed. As used herein, the term “cooling” includes leaving a molded part at room temperature.

The molded part 1b returns to its original shape at a predetermined temperature or higher, for example, a temperature near the glass transition temperature. That is, the molded part 1b deforms into its original shape (rod shape) at a temperature near the glass transition temperature. Alternatively, the curved shape shown in FIG. 1B may be the original shape of the molded part 1b, and the rod shape shown in FIG. 1A may be the deformed shape.

FIGS. 2A and 2B show an example of compressive deformation of a molded part. FIG. 2A shows a molded part 2a, the shape of which is the original shape. For example, the thick rod shape as shown in FIG. 2A is the original shape. The molded part 2a is heated at a temperature near the glass transition temperature, and an external force is applied to the heated molded part 2a. As a result, the molded part 2a is deformed. For example, as shown in FIG. 2B, the molded part 2a is deformed into a thin rod shape. As the deformed molded part 2a is cooled, its thin rod shape is memorized. Thus, a molded part 2b is formed.

The molded part 2b returns to its original shape, for example, at a temperature near the glass transition temperature. That is, the molded part 2b deforms into its original shape (thick rod shape) through expansion at a temperature near the glass transition temperature. Alternatively, the thin rod shape shown in FIG. 2B may be the original shape of the molded part 2b, and the thick rod shape shown in FIG. 2A may be the deformed shape.

A portion of the molded part may deform. FIG. 3A shows a molded part 3a, the shape of which is the original shape. For example, a rod shape is the original shape of the molded part 3a. The molded part 3a is heated at a temperature near the glass transition temperature, and an external force is applied to the heated molded part 3a. As a result, a portion of the molded part 3a is deformed. For example, as shown in FIG. 3B, the molded part 3a is deformed such that a portion of the molded part 3a extends to form a protrusion 3b. The deformed molded part 3a is cooled, thus forming a molded part 3c having the protrusion 3b.

The molded part 3c returns to its original shape at a predetermined temperature or higher, for example, a temperature near the glass transition temperature. That is, the molded part 3c deforms into its original shape (rod shape) at a temperature near the glass transition temperature. For example, the molded part 3c deforms into a rod shape as the protrusion 3b contracts. Alternatively, the shape having the protrusion 3b may be the original shape of the molded part 3c, and the rod shape may be the deformed shape. The shape and position of the deforming portion of the molded part 3a can be appropriately changed. For example, a plurality of protrusions may be formed.

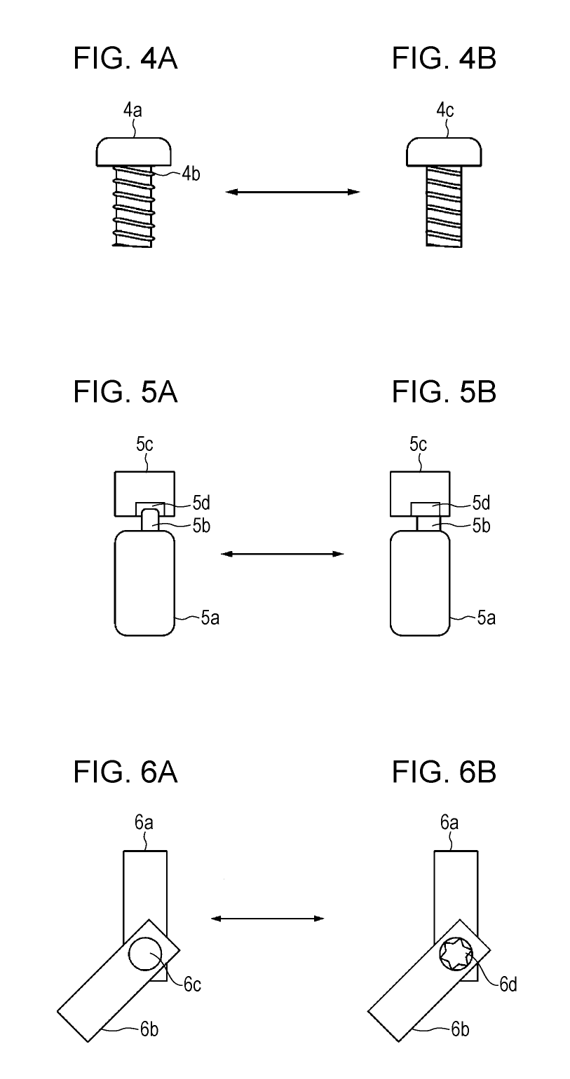

FIGS. 4A and 4B show a screw 4a. A molded part is used for a thread 4b of the screw 4a. For example, the shape having the thread 4b is the original shape. The screw 4a is heated, and an external force is applied to the heated screw 4a. As a result, the thread 4b of the screw 4a is deformed. For example, as shown in FIG. 4B, the thread 4b is deformed so as to disappear. After the deformed screw 4a is cooled, a screw 4c is formed.

The screw 4c returns to its original shape, for example, at a temperature near the glass transition temperature. That is, the screw 4c deforms at a temperature near the glass transition temperature such that the thread 4b is formed on the screw 4c. Thus, the screw 4c returns to the screw 4a having the thread 4b. After the thread 4b is formed at a temperature near the glass transition temperature, the screw 4a restores its engagement function. Alternatively, the shape having no thread may be the original shape, and the shape having the thread 4b may be the deformed shape. In this case, the screw 4a loses its engagement function after it returns to its original shape near the glass transition temperature.

In this way, a molded part having any original shape is heated at a predetermined temperature. An external force is applied to the heated molded part to deform it into any shape. As the deformed molded part is cooled, the deformed shape is maintained. Subsequently, the molded part is heated at a predetermined temperature. The molded part then returns to its original shape. The predetermined temperature is, for example, a temperature near the glass transition temperature of the shape-memory resin forming the molded part. The original and deformed shapes of the molded part can be appropriately changed.

The molded part is used as a fitting member or a part of an electronic device, as described in detail later. FIGS. 5A and 5B show an example of a molded part used for a fitting structure. FIG. 5A shows a molded part 5a. The molded part 5a has a protrusion 5b. The protrusion 5b is fitted into a recess 5d on a member 5c. As the molded part 5a is heated, it returns to its original shape. For example, a shape having a contracted protrusion 5b is the original shape. As the molded part 5a returns to its original shape, the protrusion 5b contracts. As the protrusion 5b contracts, it comes off the recess 5d.

The molded part is disposed at one or more positions of an electronic device. FIGS. 6A and 6B show an example of a molded part used for a hinge mechanism of an electronic device. As shown in FIG. 6A, members 6a and 6b are rotatable about a rotating shaft 6c. The rotating shaft 6c is a rod having a substantially circular cross section. The rotating shaft 6c is a molded part. For example, the rotating shaft 6c returns to its original shape at a temperature near the glass transition temperature. For example, as shown in FIG. 6B, a shape having a circumferential surface with ridges and valleys is the original shape. The members 6a and 6b are not rotatable about the rotating shaft 6c after it returns to its original shape. Thus, a change in the shape of the molded part can be used to control the movement of another mechanism.

### First Application of Molded Part

Next, applications of molded parts will be described. First, an application of a molded part to a battery pack will be described.

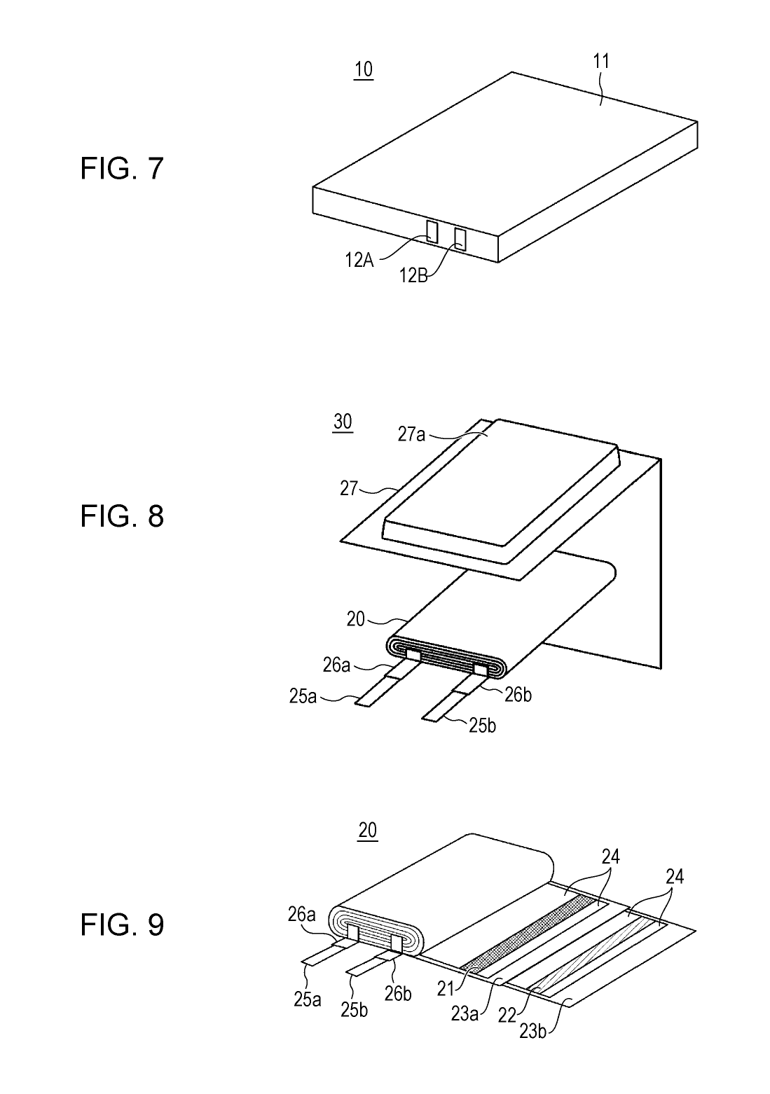

FIG. 7 shows the appearance of a battery pack to which a molded part is applied. A battery pack 10 has a flat, substantially rectangular shape and is configured such that a molded portion (casing) 11 covers a battery and a protection circuit board for the battery together. The molded portion 11 is formed of a shape-memory resin.

Openings 12A and 12B are formed in a front end surface of the molded portion 11 such that internal positive and negative electrodes are exposed therein. The internal electrodes are connected to external electrodes, for example, connection electrodes, via the openings 12A and 12B so that the battery can be charged and discharged. As described later, a cell formed by winding or stacking positive and negative electrodes together with separators is referred to as “battery cell,” an assembly formed by covering a battery cell with a laminated film is referred to as “battery,” and an assembly formed by covering the battery and the circuit board together with a shape-memory resin is referred to as “battery pack.”

As described above, the board and the battery are held together by the resin. However, the positional relationship between the board and the battery can take various forms. For example, the battery and the board may be separately covered by direct molding before being fitted or welded together.

In addition, the terminals of the board can take various shapes. Flat terminals with which pins of a device come into contact for charging and discharging are preferred in that, because the board is flat, it is easy to define the region into which the resin is allowed to flow and the region into which the resin is not allowed to flow. For terminals having a tabby shape, to which pins of a device are fitted, a resin reservoir for receiving excess resin can be provided in front of the terminals to improve productivity.

For a directly molded pack, its connectors preferably extend from the board so as to be fitted to a device. This is because, whereas the terminals preferably have high conductivity, the resin covering the board and the battery preferably has high insulation and fluidity, thus posing the risk of the conductive portions being covered. If the connectors extend from the board, the insulating resin can be easily and reliably molded without flowing onto the conductive portions of the connectors by pressing an adhesive material such as rubber against the leads of the connectors, thus improving productivity. This allows the battery pack to be provided at low cost.

Mounted on the circuit board are a protection circuit having a temperature protection device such as a fuse, a positive temperature coefficient (PTC) device, or a thermistor and other components such as an ID resistor for identifying the battery pack. In addition, the circuit board has a plurality of (for example, two or three) contacts. The protection circuit has, for example, a charging/discharging control field-effect transistor (FET) and an integrated circuit (IC) for monitoring and charging/discharging control of the secondary battery.

A PTC device is series-connected to the battery cell. If the battery temperature exceeds a preset temperature, its electrical resistance rises suddenly to substantially interrupt the current flowing through the battery. Similarly, a fuse is series-connected to the battery cell and, if an overcurrent flows through the battery, is melted and broken by the current, thus interrupting the current. In addition, a resistance heater is disposed near the fuse. If an overvoltage is applied, the fuse is melted and broken as the temperature of the resistance heater rises, thus interrupting the current.

If the terminal voltage of the secondary battery exceeds, for example, 4.3 to 4.4 V, a hazardous condition such as heat generation or ignition can occur. Therefore, the protection circuit monitors the voltage of the secondary battery and, if the voltage exceeds 4.3 to 4.4 V, that is, if the battery becomes overcharged, turns off the charging/discharging control FET to prohibit charging. On the other hand, if the terminal voltage of the secondary battery is overdischarged beyond a discharging prohibition voltage to become 0 V, the secondary battery can be no longer rechargeable as a result of an internal short-circuit. Accordingly, if overdischarging is detected while monitoring the secondary battery voltage, the charging/discharging control FET is turned off to prohibit discharging.

An example of a battery will now be described. Referring to FIGS. 8 and 9, a battery 30 includes a battery cell 20 formed by winding or stacking a positive electrode 21 and a negative electrode 22 together with separators 23a and 23b and packaged with a laminated film 27 serving as a packaging material. As shown in FIG. 8, the laminated film 27, serving as a packaging material, has a rectangular flat recess 27a that accommodates the battery cell 20. The edges (three sides other than the fold) of the laminate film 27 are thermally fused and sealed. The bonded portions of the laminated film 27 form terrace portions. The terrace portions on two sides of the recess 27a are folded toward the recess 27a.

The laminated film 27, serving as a packaging material, can be a laminated film used in the related art, for example, an aluminum laminated film. The aluminum laminated film is preferably one suitable for forming the recess 27a for accommodating the battery cell 20 by drawing.

The aluminum laminated film typically has a multilayer structure in which an adhesive layer and a surface protective layer are disposed on different surfaces of the aluminum layer. Specifically, the aluminum laminated film includes, in order from inside, that is, from the surface side of the battery cell 20, a polypropylene (PP) layer serving as an adhesive layer, an aluminum layer serving as a metal layer, and a nylon or polyethylene terephthalate (PET) layer serving as a surface protective layer.

Instead of an aluminum laminated film, the laminated film 27, serving as a packaging material, can be a single-layer or double-layer film including a polyolefin film. The laminated film 27 has a thickness of, for example, 0.2 mm or less.

As shown in FIG. 9, the strip-shaped positive electrode 21, the separator 23a, the strip-shaped negative electrode 22 disposed opposite the positive electrode 21, and the separator 23b are stacked in the above order, and the stack is then wound longitudinally. The positive electrode 21 and the negative electrode 22 are coated with a gel electrolyte 24 on both surfaces. A positive lead 25a connected to the positive electrode 21 and a negative lead 25b connected to the negative electrode 22 extend from the battery cell 20. To improve adhesion to the laminated film 27 to be laminated later, the positive lead 25a and the negative lead 25b are covered with sealants 26a and 26b, which are resin pieces such as pieces of maleic-anhydride modified polypropylene (PPa).

The components of the battery 30 will now be more specifically described, although the present disclosure can also be applied to batteries other than that described below. For example, the electrolyte used is not limited to a gel electrolyte and may be a liquid or solid electrolyte. In addition, the present disclosure can be applied not only to a battery formed by winding strip-shaped positive and negative electrodes and separators, but also to a battery formed by stacking plate-like components.

### Positive Electrode

The positive electrode 21 includes a positive current collector and positive active material layers, containing a positive active material, that are formed on both surfaces of the positive current collector. The positive current collector is, for example, a metal foil such as an aluminum (Al), nickel (Ni), or stainless (SUS) foil.

The positive active material layers contain, for example, a positive active material, a conductive agent, and a binder. The positive active material used is a lithium-transition metal composite oxide based on LiₓMO₂ (where M is at least one type of transition metal, and x is typically 0.05 to 1.10, depending on the charging/discharging state of the battery). The transition metal forming the lithium composite oxide is, for example, cobalt (Co), nickel (Ni), or manganese (Mn).

Examples of such lithium composite oxides include lithium cobaltate (LiCoO₂), lithium nickelate (LiNiO₂), and lithium manganate (LiMn₂O₄). A solid solution in which part of the transition metal element is replaced with another element can also be used. One such example is a lithium-nickel-cobalt composite oxide (such as LiNi_{0.5}Co_{0.2}O₂ or LiNi_{0.8}Co_{0.2}O₂). These lithium composite oxides can generate a high voltage with high energy density. Other examples of positive active materials include lithium-free metal sulfides and oxides such as TiS₂, MoS₂, NbSe₂, and V₂O₅. These positive active materials may be used as a mixture.

The conductive agent used is, for example, a carbon material such as carbon black or graphite. The binder used is, for example, polyvinylidene fluoride (PVdF) or polytetrafluoroethylene (PTFE). The solvent used is, for example, N-methyl-2-pyrrolidone (NMP).

### Negative Electrode

The negative electrode 22 includes a negative current collector and negative active material layers, containing a negative active material, that are formed on both surfaces of the negative current collector. The negative current collector is, for example, a metal foil such as a copper (Cu), nickel (Ni), or stainless (SUS) foil.

The negative active material layers contain, for example, a negative active material, a conductive agent, and a binder. The negative active material used is metallic lithium, a lithium alloy, a carbon material that can be doped and dedoped with lithium, or a composite material of a metal-based material and a carbon-based material. Examples of carbon materials that can be doped and dedoped with lithium include graphite, non-graphitizable carbon, and graphitizable carbon, specifically, pyrolytic carbon, coke (such as pitch coke, needle coke, and petroleum coke), graphite, glassy carbon, fired organic polymer compounds (for example, phenolic and furan resins carbonized by firing at appropriate temperature), carbon fiber, and activated carbon. Other materials that can be doped and dedoped with lithium include polymers such as polyacetylene and polypyrrole and oxides such as SnO₂ and LₓTi_{y}O_{z}, for example, Li₄Ti₅O₁₂.

Lithium can be alloyed with a wide variety of metals, among which tin (Sn), cobalt (Co), indium (In), aluminum (Al), silicon (Si), and alloys thereof are often used. For metallic lithium, a rolled metallic lithium sheet, rather than a coating of a powder mixed with a binder, can be used.

The binder used is, for example, polyvinylidene fluoride (PVdF) or styrene-butadiene rubber (SBR). The solvent used is, for example, N-methyl-2-pyrrolidone (NMP), methyl ethyl ketone (MEK), or distilled water.

### Electrolyte

The electrolyte used can be an electrolyte salt and nonaqueous solvent commonly used for lithium ion secondary batteries. Examples of nonaqueous solvents include carbonate esters such as ethylene carbonate (EC), propylene carbonate (PC), γ-butyrolactone, dimethyl carbonate (DMC), diethyl carbonate (DEC), ethyl methyl carbonate (EMC), dipropyl carbonate (DPC), and ethyl propyl carbonate (EPC), and halogen-substituted derivatives thereof. These solvents may be used alone or as a mixture in a predetermined ratio.

The electrolyte salt used is one soluble in the nonaqueous solvent and is a combination of a cation and an anion. The cation used is, for example, an alkali metal or an alkaline earth metal. The anion used is, for example, Cl⁻, Br⁻, I⁻, SCN⁻, ClO₄⁻, BF₄⁻, PF₆⁻, or CF₃SO₃⁻. Examples of such electrolyte salts include lithium hexafluorophosphate (LiPF₆), lithium tetrafluoroborate (LiBF₄), lithium bis(trifluoromethanesulfonyl)imide (LiN(CF₃SO₂)₂), lithium bis(pentafluoroethanesulfonyl)imide (LiN(C₂F₅SO₂)₂), and lithium perchlorate (LiClO₄). The electrolyte salt concentration may be any concentration at which it can be dissolved in the solvent. Preferably, the lithium ion concentration in the nonaqueous solvent is 0.4 to 2.0 mol/kg.

If a polymer electrolyte is used, it is prepared by mixing a nonaqueous solvent and an electrolyte salt to prepare a gel-like electrolytic solution and impregnating a matrix polymer with the electrolytic solution. The matrix polymer is miscible in the nonaqueous solvent. Examples of such matrix polymers include silicone gel, acrylic gel, acrylonitrile gel, polyphosphazene-modified polymers, polyethylene oxide, polypropylene oxide, and composite, cross-linked, or modified polymers thereof. Examples of fluoropolymers include polyvinylidene fluoride (PVdF), copolymers having vinylidene fluoride (VdF) and hexafluoropropylene (HFP) as repeating units, and copolymers having vinylidene fluoride (VdF) and trifluoroethylene (TFE) as repeating units. These polymers may be used alone or as a mixture of two or more.

The polymer electrolyte preferably contains a metal oxide or composite metal oxide containing silicon, aluminum, titanium, zirconium, or tungsten. This ensures insulation in the event of an abnormal condition, thus improving safety and reliability, and also provides the effect of inhibiting expansion at elevated temperatures.

### Separator

The separators 23a and 23b are formed of, for example, porous films of a polyolefin such as polypropylene (PP) or polyethylene (PE) or porous films of an inorganic material such as ceramic nonwoven fabric. Two or more types of such porous films can also be stacked. Among them, porous films of polypropylene and polyethylene are most effective.

In general, the thickness of the separators is preferably 5 to 50 mm, more preferably 7 to 30 μm. If the separators are extremely thick, the amount of active material contained decreases, thus decreasing the capacity of the battery, and the ionic conductivity also decreases, thus degrading current characteristics. If the separators are extremely thin, on the other hand, the mechanical strength of the films decreases.

### Method for Manufacturing Battery Pack

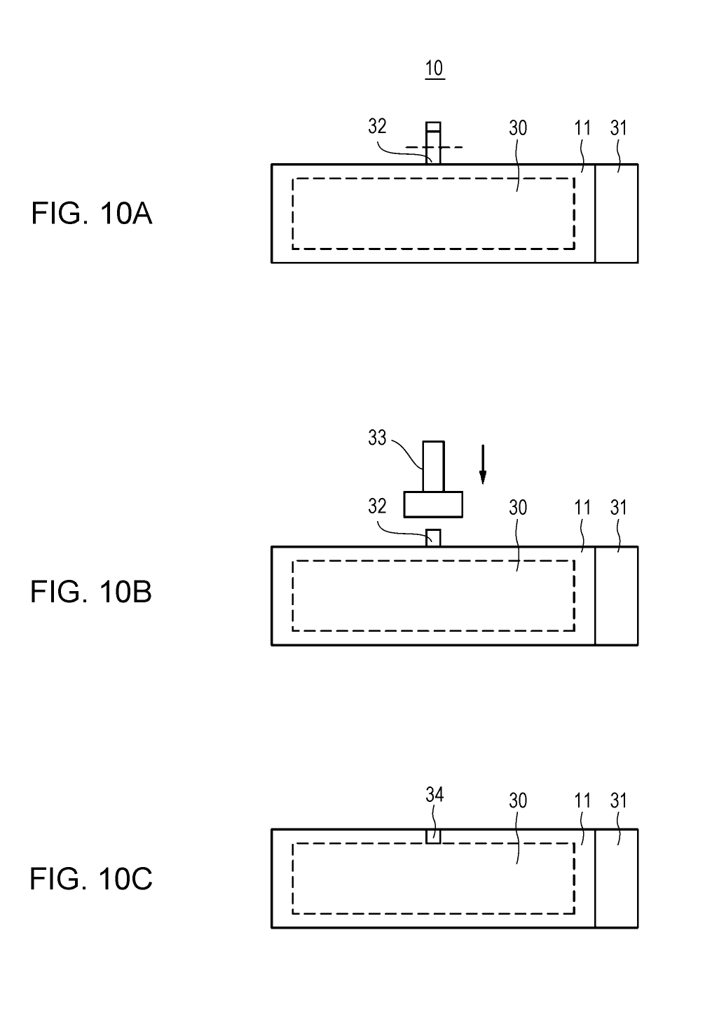

An example of a method for manufacturing the above battery pack 10 will now be described with reference to FIGS. 10A to 10C. As schematically shown in FIG. 10A, a battery 30 and a circuit board 31 accommodated in a holder are placed in a molding space of a mold (not shown). The molding space is filled with a shape-memory resin to form a molded portion 11. The molded portion 11 combines the battery 30 and the circuit board 31 together.

A protrusion 32 for removing bubbles is formed on the molded portion 11 so that no bubble remains in the shape-memory resin. The protrusion 32 is formed, for example, on the largest surface of the battery pack 10 at a position where bubbles tend to remain. The protrusion 32 is used in treatment for removing bubbles. The protrusion 32 avoids a bubble-biting failure due to residual bubbles to improve productivity. However, the protrusion 32 remains on the surface of the battery pack 10.

Therefore, after the molded portion 11, formed of a shape-memory resin, is cured, an external force is applied to the protrusion 32 in a heated state. For example, the protrusion 32 is heat-pressed. A tip of the protrusion 32 where bubble remains may be cut before heat pressing. This shape having the protrusion 32 is an example of the original shape of the molded portion 11.

As shown in FIG. 10B, the protrusion 32 is heat-pressed by pressing a pressing device 33, such as an impulse welder, against the protrusion 32. The temperature of the pressing device 33 is higher than or equal to the glass transition temperature of the shape-memory resin forming the molded portion 11. As a result, as shown in FIG. 10C, the protrusion 32 is compressed, and the surface on which the protrusion 32 is formed becomes substantially flat. As the protrusion 32 is compressed, a strained portion 34 is formed. The strained portion 34 can thus be formed with the pressing device 33 after molding and curing to ensure the intended amount and position of heat deformation at a predetermined temperature.

The battery pack 10 thus formed is accommodated in an electronic device. For example, the battery pack 10 is accommodated such that the surface on which the strained portion 34 is formed faces a power supply lid for covering the battery pack 10. If the battery 30 of the battery pack 10 heats up abnormally due to, for example, entry of foreign matter, the heat generated by the battery 30 is transferred to the molded portion 11. When the molded portion 11 is heated to near the glass transition temperature, it returns to its original shape. That is, the molded portion 11 returns to its original shape such that the strained portion 34 extends to form the protrusion 32.

As the protrusion 32 is formed, it pushes and forces the power supply lid to come off. After the lid comes off, the battery pack 10 is released from the electronic device. Alternatively, a switch that opens the power supply lid may be pressed by the protrusion 32 formed as a result of deformation. That is, the switch may be pressed to open the power supply lid, thereby releasing the battery pack 10 from the electronic device. In this way, the battery pack 10 that has heated up abnormally can be released from the electronic device.

### Second Application of Molded Part

Next, a second application of a molded part to a battery pack will be described. The appearance and structure of the battery pack will not be described here because they are the same as those of the first application.

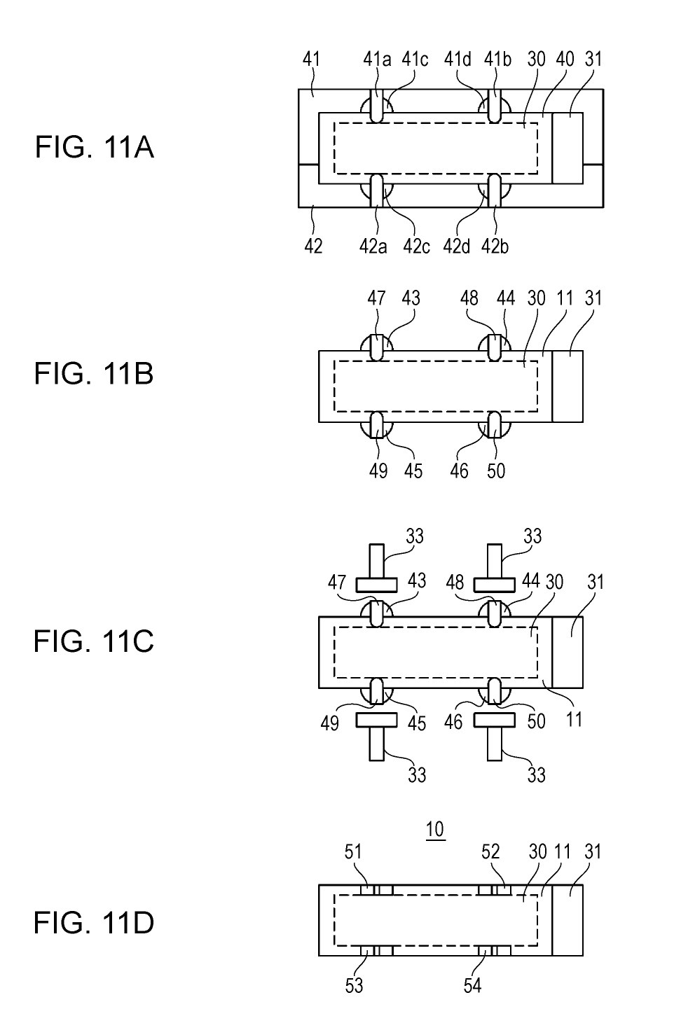

Another example of a method for manufacturing the battery pack 10 will be described with reference to FIGS. 11A to 11D. As schematically shown in FIG. 11A, a battery 30 and a circuit board 31 accommodated in a holder are placed in a molding space (cavity) 40 of a mold. The mold is composed of a male mold half 41 and a female mold half 42 that have flat mating surfaces. The male mold half 41 and the female mold half 42 are formed of, for example, a metal, plastic, or ceramic. The male mold half 41 and the female mold half 42 are mated together to form the molding space 40.

The male mold half 41 has battery-positioning portions 41a and 41b as protrusions for positioning the battery 30. The female mold half 42 has battery-positioning portions 42a and 42b as protrusions for positioning the battery 30. The four battery-positioning portions 41a, 41b, 42a, and 42b set the position of the battery 30 in the molding space 40. The positions and number of battery-positioning portions, for example, can be appropriately changed.

Spaces are formed around the individual battery-positioning portions 41a, 41b, 42a, and 42b. For example, spaces 41c and 41d are formed around the battery-positioning portions 41a and 41b, respectively. Similarly, spaces 42c and 42d are formed around the battery-positioning portions 42a and 42b, respectively.

After the battery 30 and the circuit board 31 are positioned in the molding space 40, a shape-memory resin is injected into the molding space 40 and the spaces 41c, 41d, 42c, and 42d through a channel (not shown). After the shape-memory resin is cured, the male mold half 41 and the female mold half 42 are separated. As shown in FIG. 11B, the molded part 11 covering the battery 30 is formed.

The shape-memory resin is injected into the spaces 41c, 41d, 42c, and 42d to form protrusions 43, 44, 45, and 46, respectively, on the molded portion 11. In addition, the battery-positioning portions 41a, 41b, 42a, and 42b are removed to form holes 47, 48, 49, and 50, respectively, on the molded portion 11. This shape is an example of the original shape of the molded portion 11.

Next, an external force is applied to the four protrusions 43, 44, 45, and 46 in a heated state. For example, as shown in FIG. 11C, the four protrusions 43, 44, 45, and 46 are heat-pressed by pressing pressing devices 33 thereagainst. The temperature of the pressing devices 33 is higher than or equal to the glass transition temperature of the shape-memory resin forming the molded portion 11. The four protrusions 43, 44, 45, and 46 may be heat-pressed simultaneously or sequentially.

As shown in FIG. 11D, the protrusions 43, 44, 45, and 46 are compressed by heat pressing. As the protrusions 43, 44, 45, and 46 are compressed, the surface of the molded portion 11 becomes substantially flat. A strained portion 51 is formed at the position where the protrusion 43 is heat-pressed on the molded portion 11. A strained portion 52 is formed at the position where the protrusion 44 is heat-pressed on the molded portion 11. A strained portion 53 is formed at the position where the protrusion 45 is heat-pressed on the molded portion 11. A strained portion 54 is formed at the position where the protrusion 46 is heat-pressed on the molded portion 11.

The battery pack 10 thus formed is accommodated in an electronic device. For example, the battery pack 10 is accommodated such that the surface on which the strained portions 51 and 52 are formed faces a power supply lid for covering the battery pack 10. If the battery 30 of the battery pack 10 heats up abnormally due to, for example, entry of foreign matter, the heat generated by the battery 30 is transferred to the molded portion 11. When the molded portion 11 is heated to near the glass transition temperature, it returns to its original shape. That is, the molded portion 11 returns to its original shape such that the strained portions 51, 52, 53, and 54 extend. As the strained portions 51, 52, 53, and 54 extend, they form the protrusions 43, 44, 45, and 46, respectively.

As the four protrusions 43, 44, 45, and 46 are formed, at least one of them pushes and forces the power supply lid of the electronic device to come off. After the lid comes off, the battery pack 10 is released from the electronic device. Alternatively, a switch that opens the power supply lid may be pressed by at least one protrusion formed as a result of deformation. That is, the switch may be pressed to open the power supply lid, thereby releasing the battery pack 10 from the electronic device. In this way, the battery pack 10 that has heated up abnormally can be released from the electronic device.

In addition, the following advantage is provided by injecting the shape-memory resin into the spaces 41c, 41d, 42c, and 42d to form the protrusions 43, 44, 45, and 46 such that the thickness of the molded portion 11 around the battery-positioning portions 41a, 41b, 42a, and 42b is larger than that of the other portion. After the resin is cured, the male mold half 41 and the female mold half 42 are separated, and the four battery-positioning portions 41a, 41b, 42a, and 42b are removed. The four holes 47, 48, 49, and 50 are formed when the battery-positioning portions 41a, 41b, 42a, and 42b are removed.

The protrusions 43, 44, 45, and 46 are formed and heat-pressed. By heat pressing, the protrusions 43, 44, 45, and 46 are deformed. The deformed protrusions 43, 44, 45, and 46 enter the holes 47, 48, 49, and 50, respectively. This makes the surfaces of the battery pack 10 substantially flat, thus avoiding a poor appearance. In addition, the battery pack 10 can be manufactured at low cost without using a mold of complicated shape.

A battery pack that has experienced an abnormally high temperature might cause a malfunction or temperature rise when reused. For the battery pack 10 according to this embodiment, the protrusions 43, 44, 45, and 46 prevent the battery pack 10 from being attached to, for example, an electronic device, thus avoiding reuse of the battery pack 10.

The molding space 40 is filled with the shape-memory resin under a certain pressure so that no gap remains in the molding space 40. Therefore, various measures may be taken to prevent the shape-memory resin being injected under pressure from displacing the battery 30 and the circuit board 31 from the predetermined positions in the molding space 40. For example, the shape-memory resin may be injected in two or more steps. Specifically, the battery 30 and the circuit board 31 may be held at predetermined positions, with some space left unfilled, before the shape-memory resin is injected throughout the molding space 40. A positioning part can also be used; for example, a tape, rubber piece, or mesh to be molded together may be wound around the cell by one turn.

Noticeable heat generation during curing and curing contraction during the process from two-component mixing to curing may occur, depending on the composition of the shape-memory resin. To suppress heat generation during curing, it is preferable to inject a low-molecular-weight resin having sufficiently low viscosity as the resin mix at a low temperature, namely, 40° C. or lower. The molding space 40 preferably has a sufficiently large volume, and the mold 41 is preferably formed of a material having high thermal conductivity such as aluminum or stainless steel. As for curing contraction, it is preferable to provide a resin reservoir on the mold 41 and inject a sufficiently larger amount of resin so that the resin mix can be supplied from the resin reservoir as it cures and contracts.

A modification of the battery pack 10 will now be described. The laminated film 27 may be a single-layer or double-layer film including a polyolefin film, rather than an aluminum laminated film.

In this case, the resin used is preferably a urethane resin. Preferably, the weight mixing ratio (base/curing agent) of the polyol, serving as a base, and the isocyanate, serving as a curing agent, in the urethane resin is 1 or less, and the content of molecular chains derived from diphenylmethane diisocyanate (MDI) is at least 20% by weight of the total amount of base and curing agent. This provides the urethane resin with significant moisture barrier properties. More preferably, the weight mixing ratio (base/curing agent) of the polyol, serving as a base, and the isocyanate, serving as a curing agent, in the urethane resin is 0.7 or less, and the content of molecular chains derived from diphenylmethane diisocyanate (MDI) is at least 40% by weight of the total amount of base and curing agent. This provides the urethane resin with more significant moisture barrier properties.

Such a urethane resin forms a molded portion 11 with superior moisture barrier properties, thus allowing the use of a single-layer or double-layer film including a polyolefin film, rather than an aluminum laminated film.

In addition, a deposited layer is preferably formed on the surface of the polyolefin film by, for example, vacuum deposition or sputtering to improve the moisture barrier properties. The deposited layer can be formed of a material used in the related art, such as silica, alumina, aluminum, zinc, zinc alloy, nickel, titanium, copper, or indium. In particular, aluminum is preferably used.

For an aluminum laminated film to be drawn in the thickness direction of the battery, an aluminum layer having a thickness of about 20 μm is formed, and a nylon or PET layer having a thickness of about 15 to 30 μm is formed to protect the aluminum layer during drawing. This tends to decrease the volumetric energy density by about 10%.

On the other hand, if the battery cell 20 is sealed with a thin polyolefin film impermeable to the electrolyte of the battery cell 20 and having moisture barrier properties before aluminum is deposited thereon to form a deposited layer, an aluminum layer having a thickness of 10 μm or less, which is half or less that in the related art, can be used to provide moisture barrier properties.

In addition, a nylon or PET layer can be omitted because drawing is not carried out. The battery cell 20 can therefore be covered with a single-layer or double-layer packaging film before the molding of the urethane resin to ensure reliability higher than or equal to that in the related art. The packaging film used can instead be a clay-mineral-based film such as Claist®. A clay mineral film, which has poor flexibility but superior moisture barrier properties, is preferred in that it allows a reduction in film thickness to improve the volumetric energy density of the battery pack 10.

In addition, a laminated film package has the risk of breakage of the aluminum layer and entry of more moisture due to peeling of the CPP layer from the aluminum layer upon bending a sealed end surface. In contrast, the moisture barrier properties of the urethane resin and the deposition of aluminum after the sealing of the battery 30 provide the advantageous effect of significantly improving the battery capacity without causing the above problems. Aluminum is preferably deposited in two or more layers to form a multilayer deposited film. For multilayer deposition, even an aluminum layer having a thickness of 1 μm or less has sufficient reliability, although the thickness is preferably 0.03 μm or more because a thickness below 0.03 μm may result in pinholes in the deposited surface.

### Third Application of Molded Part

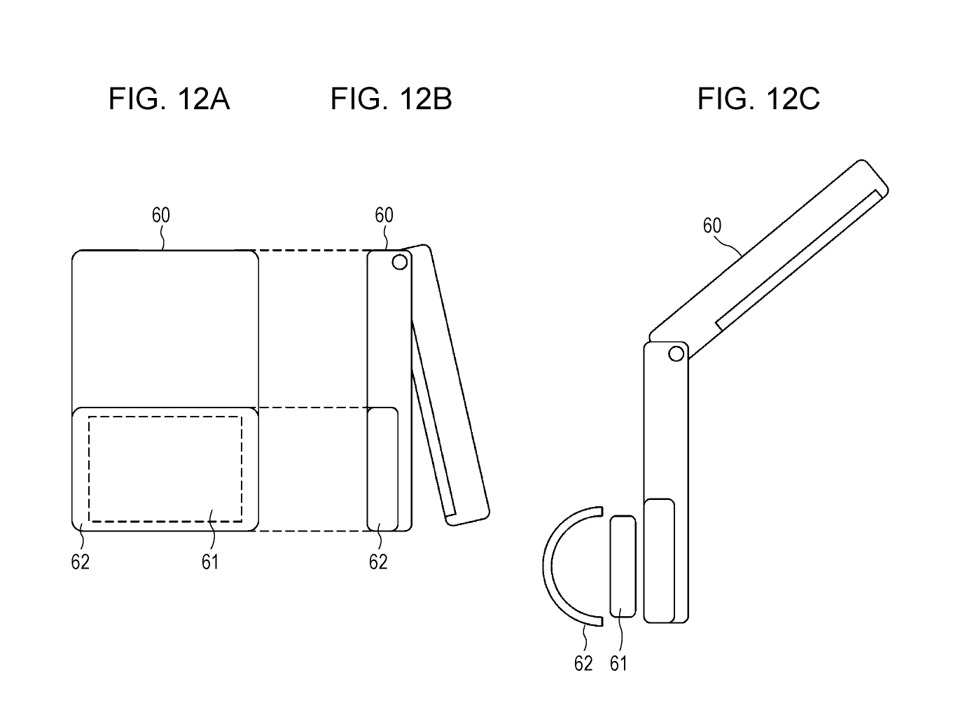

Next, a third application of a molded part will be described with reference to FIGS. 12A to 12C. In the third application, a molded part is disposed near a power supply of a notebook personal computer.

FIG. 12A shows an example of a bask surface of a notebook personal computer, and FIG. 12B shows an example of a side surface of the notebook personal computer. As shown in FIG. 12A, a notebook personal computer 60 has a power supply 61. The power supply 61 is composed of, for example, one or more battery packs including lithium ion batteries. A shape-memory resin 62 is disposed around the power supply 61. The shape-memory resin 62 covers the power supply 61 to serve as, for example, a lid for the power supply 61.

If the power supply 61 heats up abnormally due to, for example, entry of foreign matter, the heat generated by the power supply 61 raises the temperature around the shape-memory resin 62 to near the glass transition temperature of the shape-memory resin 62. The shape-memory resin 62 disposed around the power supply 61 then returns to its original shape. The original shape of the shape-memory resin 62 is, for example, a curved shape.

As the shape-memory resin 62 returns to its original shape, it comes off the personal computer 60, as shown in FIG. 12C. After the shape-memory resin 62 comes off, the power supply 61 is released from the personal computer 60. In this way, the power supply 61 that has heated up abnormally can be released without user operation. This ensures the safety of an electronic device such as a notebook personal computer.

Displays, protection circuits, and glass epoxy printed boards used in electronic devices such as notebook personal computers are susceptible to high temperatures; they are only resistant to temperatures up to about 130° C. In this embodiment, a power supply that has heated up abnormally can be released from the electronic device. This prevents a power supply that has heated up abnormally from affecting a part having low heat resistance, such as a display of an electronic device.

In addition, the shape-memory resin used in this embodiment does not melt at low temperatures, as do thermoplastic resins, and or have high thermal conductivity, as do metals. This prevents molten resin from affecting other parts.

### Fourth Application of Molded Part

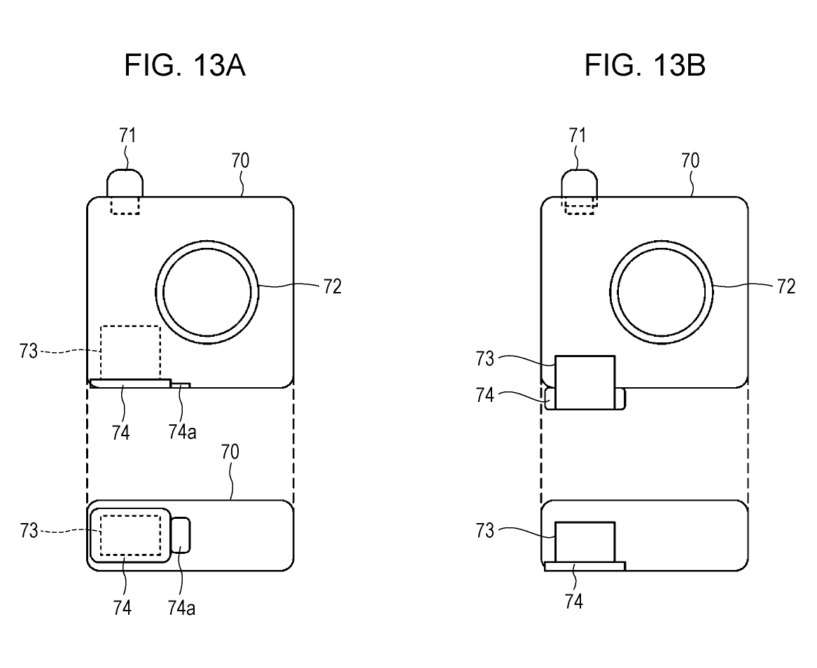

Next, a fourth application of a molded part will be described with reference to FIGS. 13A and 13B. In the fourth application, a molded part is applied to a digital camera.

FIG. 13A shows front and bottom views of a digital camera 70 in normal use. A digital camera 70 has, for example, a shutter button 71 and a lens 72. A power supply 73 is incorporated in the digital camera 70. The power supply 73 is, for example, a lithium ion battery detachable from the digital camera 70.

The digital camera 70 has a power supply lid 74. The power supply lid 74 is rotatable and is joined to a spring (not shown). In addition, the power supply lid 74 has a slidable catch 74a.

The power supply lid 74 is rotated and closed, and the catch 74a is slid in a predetermined direction in that state. The catch 74a is slid until it fits into a predetermined portion of the digital camera 70. To open the power supply lid 74, the catch 74a is slid in the direction opposite the predetermined direction and is detached from the predetermined portion of the digital camera 70. After the catch 74a is detached from the predetermined portion, the power supply lid 74 is opened by the action of the spring. In the fourth application, the shutter button 71 and the catch 74a of the power supply lid 74 are molded parts formed of a shape-memory resin.

FIG. 13B shows the digital camera 70 after the power supply 73 heats up abnormally. If the power supply 73 heats up abnormally, the generated heat is transferred to the shutter button 71. When the heat from the power supply 73 raises the temperature of the shutter button 71 to near the glass transition temperature of the shape-memory resin forming the shutter button 71 and the catch 74a, the shutter button 71 returns to its original shape. The original shape is, for example, a shape surrounded by a protrusion.

As the shutter button 71 returns to its original shape, a protrusion is formed. This protrusion prevents the shutter button 71 from being pressed, thus avoiding the use of the digital camera 70 after the power supply 73 heats up abnormally.

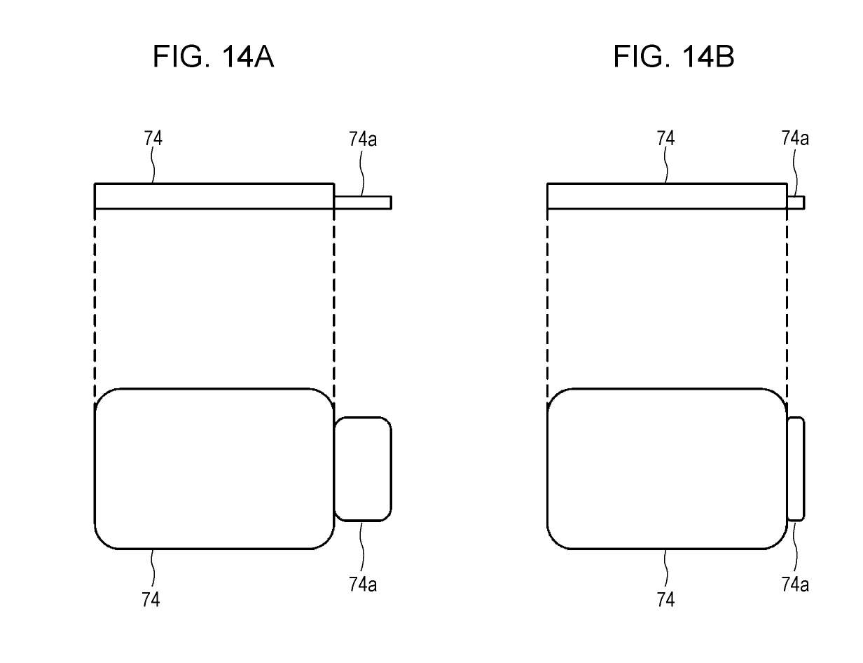

In addition, as shown in FIG. 13B, the power supply lid 74 may be configured to be opened to release the power supply 73 that has heated up abnormally from the digital camera 70. FIG. 14A shows side and bottom views of the power supply lid 74 and the catch 74a. The catch 74a is fitted into the predetermined portion of the digital camera 70 to close the power supply lid 74.

FIG. 14B shows side and bottom views of the power supply lid 74 and the catch 74a after the power supply 73 heats up abnormally. If the power supply 73 heats up abnormally, the generated heat is transferred to the catch 74a. When the generated heat raises the temperature of the catch 74a to near the glass transition temperature of the catch 74a, the catch 74a returns to its original shape. The original shape of the catch 74a is, for example, a contracted shape.

As the catch 74a returns to its original shape, it contracts. As the catch 74a contracts, it comes off the predetermined portion of the digital camera 70. The power supply lid 74 is then opened by the action of the spring, thus releasing the power supply 73 from the digital camera 70. It is also possible to form the entire power supply lid 74, rather than only the catch 74a, of a shape-memory resin so that the entire power supply lid 74 contracts.

### Fifth Application of Molded Part

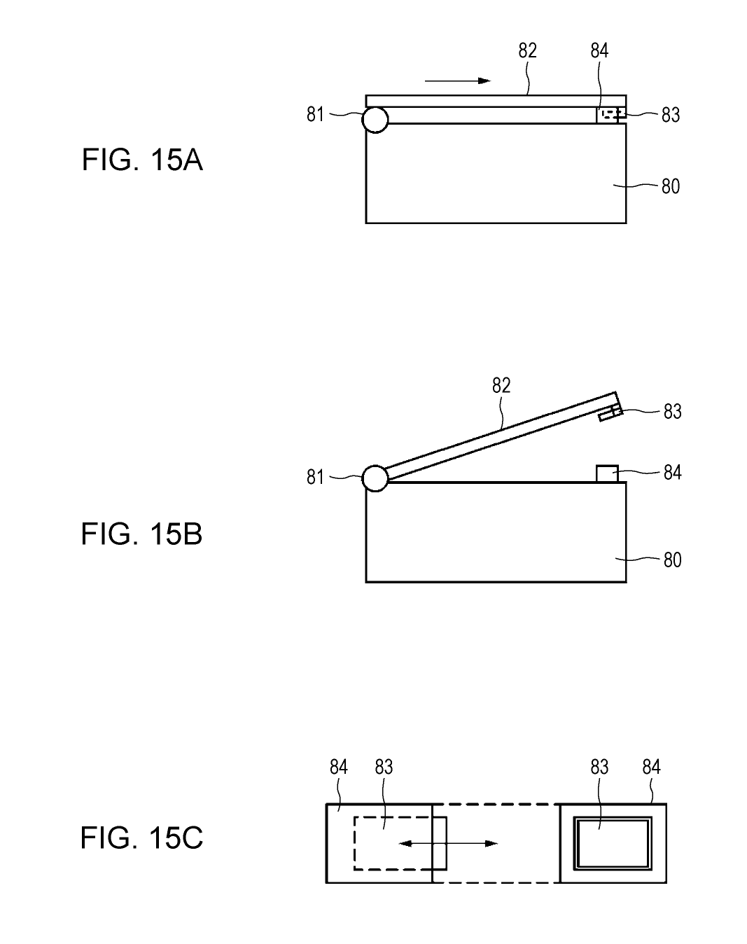

In a fifth application, a molded part is applied to a fitting portion of a hinge mechanism. FIGS. 15A to 15C show the hinge mechanism in normal use. As shown in FIG. 15A, a housing 80 has a rotating shaft (hinge) 81 at one end and a fitting portion 84 at the other end. The fitting portion 84, which is an example of a molded part, is formed of a shape-memory resin. The housing 80 accommodates a power supply (not shown).

A lid 82 has the rotating shaft 81 attached to one end thereof and a catch 83 that fits into the fitting portion 84 at the other end thereof. The catch 83 is fitted into the fitting portion 84 to close the lid 82. The rotating shaft 81 has a spring (not shown), and the lid 82 is opened by the action of the spring. For example, as shown in FIG. 15B, the lid 82 is moved to the right of the figure to detach the catch 83 from the fitting portion 84. The lid 82 is then opened by the force of the spring of the rotating shaft 81. FIG. 15C shows enlarged side and bottom views of the catch 83 and the fitting portion 84. As the catch 83 is slid to the left or right, the catch 83 is fitted into or detached from the fitting portion 84.

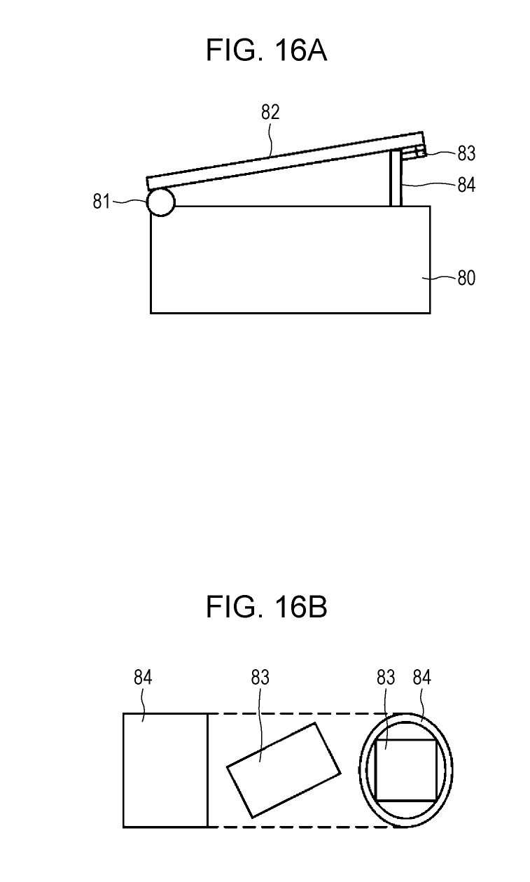

FIGS. 16A and 16B show the catch 83 and the fitting portion 84 fitted together after the power supply 73 heats up abnormally. If the power supply heats up abnormally, the generated heat is transferred to the fitting portion 84. When the heat raises the temperature of the fitting portion 84 to the glass transition temperature of the shape-memory resin forming the fitting portion 84 or higher, the fitting portion 84 returns to its original shape. The original shape is, for example, an expanded shape.

As the fitting portion 84 expands, the catch 83 comes off the fitting portion 84. The lid 82 is then lifted and opened by the force of the spring. As the lid 82 is opened, the heat dissipation area of the housing 80 is increased, thus facilitating heat dissipation. FIG. 16B shows enlarged views of the catch 83 and the fitting portion 84. As the fitting portion 84 returns to its original shape, the catch 83 comes off the fitting portion 84.

The fifth application can be applied in various manners. For example, the lid 82 can be used as a power supply lid. Alternatively, the fifth application can be applied to a notebook personal computer. For example, the housing 80 can be configured as a keyboard, and the lid 82 can be configured as a liquid crystal display. If the fifth application is applied to a notebook personal computer, it can be combined with the technique of the third application described with reference to FIGS. 12A to 12C.

### Sixth Application of Molded Part

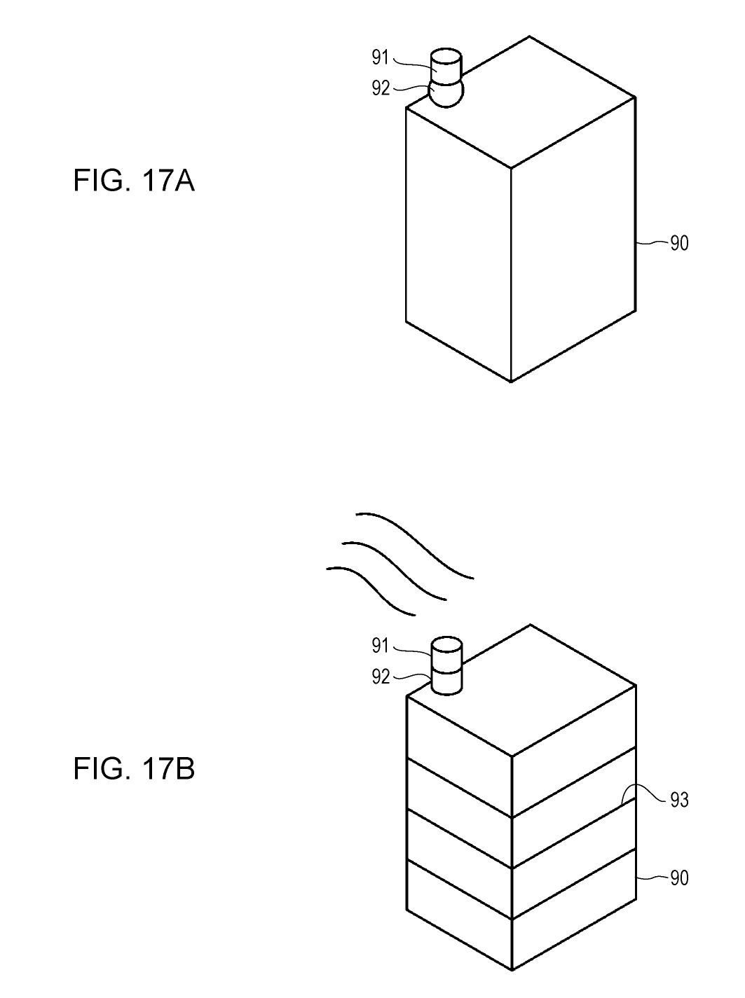

A sixth application of a molded part will now be described with reference to FIGS. 17A and 17B. FIG. 17A shows a power supply 90 formed by accommodating a group of batteries in a case and potting it. The power supply 90 has a button 91. The button 91, which is an example of a switch mechanism, is a button for starting a cooling unit (not shown). The button 91 is pressed to start the cooling unit. The button 91 is integrated with a molded part 92.

FIG. 17B shows a power supply 90 that has heated up abnormally. If the power supply 90 heats up abnormally, the generated heat is transferred to the molded part 92. When the heat raises the temperature of the molded part 92 to its glass transition temperature or higher, the molded part 92 returns to its original shape. The original shape is, for example, a shape contracted after softening.

As the molded part 92 returns to its original shape, the button 91 is pressed. When the button 91 is pressed, the cooling unit is started. For example, the cooling unit is started to cool the power supply 90 with air. Alternatively, water cooling may be performed on the power supply 90 by allowing water to flow through channels 93 provided around the power supply 90. For example, circulated water cooling may be performed on the power supply 90 if it is mounted on an automobile.

### Seventh Application of Molded Part

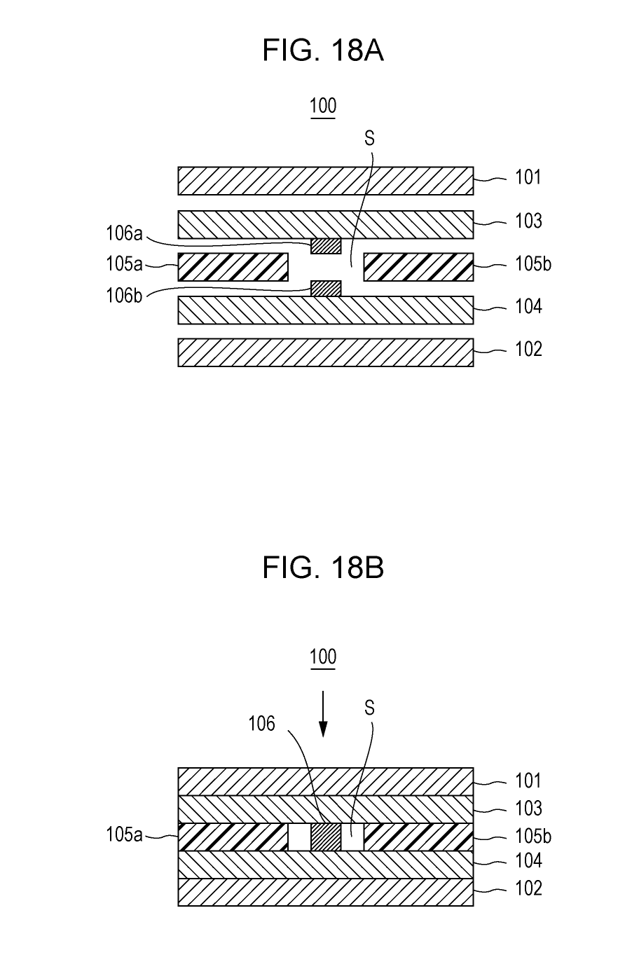

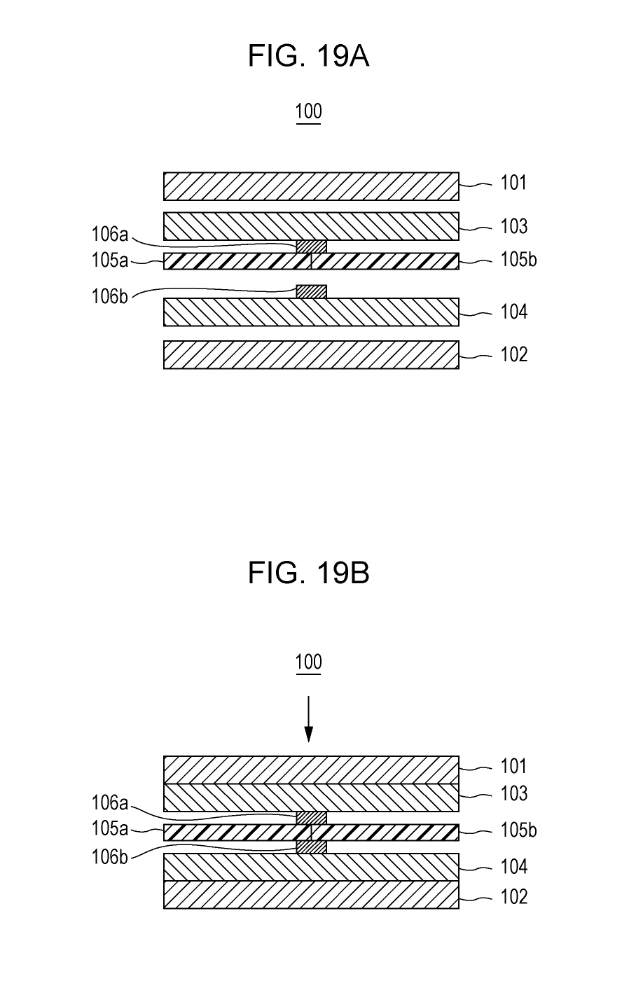

A seventh application of a molded part will now be described with reference to FIGS. 18A, 18B, 19A, and 19B. FIGS. 18A and 18B show an example of the cross-sectional structure of a switch 100. The switch 100 includes a top sheet 101 and a bottom sheet 102. An upper electrode sheet 103 and a lower electrode sheet 104 are disposed between the top sheet 101 and the bottom sheet 102. The upper electrode sheet 103 has a contact 106a, whereas the lower electrode sheet 104 has a contact 106b. Spacers 105a and 105b are disposed between the electrode sheets 103 and 104. The spacers 105a and 105b form a space S. The spacers 105a and 105b are formed of a shape-memory resin.

In the normal use of the switch 100, as shown in FIG. 18B, the top sheet 101 is pressed. The contacts 105a and 105b then come into contact in the space S formed by the spacers 105a and 105b. As the contacts 105a and 105b come into contact, the upper electrode sheet 103 and the lower electrode sheet 104 are electrically connected together, thus activating the switch 100.

FIGS. 19A and 19B show a switch 100 exposed to an abnormal ambient temperature. For example, if the ambient temperature reaches the glass transition temperature of the shape-memory resin forming the spacers 105a and 105b or higher, the spacers 105a and 105b return to their original shape. The original shape is, for example, an expanded shape.

As the spacers 105a and 105b expand and return to their original shape, the space disappears, as shown in FIG. 19A. If the top sheet 101 is pressed in this state, the spacers 105a and 105b prevent the contacts 105a and 105b from coming into contact, as shown in FIG. 19B. Therefore, the switch 100 is not activated. In this way, the switch 100 can be prevented from being activated when exposed to an abnormal ambient temperature.

Whereas a plurality of embodiments (applications) have been specifically described, it should be understood that various modifications are permitted. For example, the techniques according to the embodiments can also be applied to batteries other than lithium ion batteries. In addition, the techniques according to the embodiments can be applied to energy storage devices such as capacitors. Furthermore, the techniques according to the embodiments can be applied to components that heat up other than batteries.

Whereas the molded portion 11 covers the surface of the battery 30 in the above applications, it may partially cover the surface of the battery 30. In addition, the molded portion 11 does not have to cover the circuit board 31 together with the battery 30. The shape-memory resin may at least partially cover the surface of the battery 30. The molded portion 11 may at least partially cover the surface of a battery group composed of battery packs. The molded portion 11 may return to its original shape by deforming in its entirety.

In the above embodiments, a molded part formed of a shape-memory resin is used to improve the safety of a device. It should be understood that the molded part can also be used in combination with a safety mechanism that has been proposed in the related art, such as the mechanism by which the power supply is stopped when, for example, a thermistor detects abnormal heat generation. A plurality of safety mechanisms can be provided for a power supply without decreasing the volumetric energy density of the power supply.

The techniques of the above applications can also be used in other techniques as long as there is no technical contradiction. In addition, the advantages of the above applications can also be provided in other applications as long as there is no technical contradiction.

### EXAMPLES AND COMPARATIVE EXAMPLES

Examples and comparative examples will now be described for a better understanding of the present disclosure, although the content of the present disclosure is not limited to the examples and comparative examples below.

First, the measurement methods used in the examples and comparative examples will be described.

To determine the glass transition temperature, a stress-temperature curve was obtained by measuring stress using a TMA/SS7100 thermomechanical analyzer (TMA) from SII NanoTechnology Inc. in a constant-load stress measurement mode at a heating rate of 10° C./min. The glass transition temperature (Tg) was determined from the tangent at the temperature at which the stress dropped sharply in the stress-temperature curve.

Strain analysis was carried out using an LSM-601 strain analyzer from Luceo Co., Ltd. to demonstrate that a particular portion heated and deformed after molding was colored and strained.

The resins for the molded parts were molded into No. 1 test pieces specified by JIS K7113. A measurement was carried out at 25° C. and 1 mm/min using an AG-5kNX universal tester from Shimadzu Corporation equipped with a constant-temperature bath. Of the measurement results, the elongation in the elastic region up to the maximum yield stress was determined as the elastic strain at room temperature. The same measurement was also carried out at an ambient temperature of the glass transition temperature measured by TMA+10° C. to determine the elastic strain at the softening temperature. When the test pieces stretched to the maximum yield stress at the softening temperature were stored in the constant-temperature bath after the test, they returned to the lengths of their original sample shapes, demonstrating that the deformation of the test pieces was elastic deformation.

To measure the temperature of a printed board of a liquid crystal display in a cellular phone, a K-type thermocouple was bonded to the printed board, and the maximum temperature was measured using a GL220 data logger from Graphtec Corporation. To reproduce the abnormal charging mode of the power supply, the cellular phone was placed in a constant-temperature bath at 45° C. and was supplied with a 1 C current, namely, a current of 1,650 mA, at 12 V for two and a half hours with the protection circuit of the battery short-circuited and inoperable.

To measure the stress of a flexible board disposed at a hinge of a cellular phone, a strain gauge from Kyowa Electronic Instruments Co., Ltd. having a gauge length of 2 mm was bonded to both surfaces of the flexible board, and the maximum stress was measured using a GL220 data logger from Graphtec Corporation. To reproduce the abnormal charging mode of the power supply, the cellular phone was placed in a constant-temperature bath at 45° C. and was supplied with a 1 C current, namely, a current of 1,650 mA, at 12 V for two and a half hours with the protection circuit of the battery short-circuited and inoperable. The maximum temperature of the printed board, the maximum stress on both surfaces of the flexible board, and other data are shown in Table 1.

| | | Type of | | | | Glass | Property |
|---|---|---|---|---|---|---|---|
| | | strained | | | | transition | change |
| | Reaction- | resin | Type of | Curing | Curing | point (Tg) | ratio after |
| | curable resin | molded part | deformation | method | time | (° C.) | heating |
| Ex. 1 | Silicone | Power | Bending | 120° C. | 30 min | 60 | 22 |
| | | supply | | | | | |
| | | cover | | | | | |
| Ex. 2 | Epoxy | Hinge pin | Compression | 110° C. | 20 min | 140 | 12 |
| Ex. 3 | Urethane | Battery | Partial | 100° C. | 20 min | 77 | 12 |
| | | group | deformation | | | | |
| | | casing | | | | | |
| Ex. 4 | Acrylic | Power | Fitting | 90° C. | 15 min | 123 | 13 |
| | | supply | | | | | |
| | | cover | | | | | |
| Ex. 5 | Polyurethane | Folding | Moving | 85° C. | 10 min | 80 | 10 |
| | | portion | portion | | | | |
| Ex. 6 | Epoxy | Interior of | Extension | 79° C. | 9 min | 80 | 8 |
| | | operating | | | | | |
| | | button | | | | | |
| Ex. 7 | Polyurethane | Battery | Protrusion | 80° C. | 10 min | 120 | 1.1 |
| | | pack | | | | | |
| | | casing | | | | | |
| | | (framed) | | | | | |
| Ex. 8 | Polyurethane | Battery | Protrusion | 80° C. | 5 min | 85 | 2 |
| | | pack | with bubble | | | | |
| | | casing | portion cut | | | | |
| | | (framed) | | | | | |
| Ex. 9 | Polyurethane | Battery | Protrusion | 80° C. | 3 min | 90 | 6 |
| | | pack | | | | | |
| | | casing | | | | | |
| | | (frameless) | | | | | |
| Ex. 10 | Polyurethane | Battery | Protrusion | 80° C. | 3 min | 100 | 5 |
| | | pack | | | | | |
| | | casing | | | | | |
| | | (frameless) | | | | | |
| Ex. 11 | Polyurethane | Battery | Protrusion | 80° C. | 3 min | 105 | 5 |
| | | pack | | | | | |
| | | casing | | | | | |
| | | (frameless) | | | | | |
| Ex. 12 | Polyurethane | Battery | Protrusion | 80° C. | 3 min | 110 | 5 |
| | | pack | | | | | |
| | | casing | | | | | |
| | | (frameless) | | | | | |
| Com. | Silicone | Power | No strain | 120° C. | 20 min | −20 | 1.08 |
| Ex. 1 | | supply | | | | | |
| | | cover | | | | | |
| Com. | Epoxy | Power | No strain | Left | 1 day | 155 | 1.05 |
| Ex. 2 | | supply | | standing | | | |
| | | cover | | at room | | | |
| | | | | temperature | | | |
| Com. | Thermoplastic | Power | No strain | Hot-melt | 20 sec | 120 | 121 |
| Ex. 3 | polycarbonate | supply | | extrusion | | | |
| | | cover | | at 200° C. | | | |
| Com. | Thermoplastic | Power | No strain | Hot-melt | 30 sec | 50 | 105 |
| Ex. 4 | polypropylene | supply | | extrusion | | | |
| | | cover | | at 220° C. | | | |

| | | | Number | | | |
|---|---|---|---|---|---|---|
| | | | of covering | Maximum | Stress of | |
| | | | defects | temperature | flexible board | |
| | | | after | of printed | at hinge after | |
| | | | injection | board after 12 V | 12 V 1 C | |
| | | Nominal | of | 1 C | overcharging | Expansion |
| | | energy | reaction- | overcharging | test with | after |
| | | density | curable | test with | protection | storage test |
| | | of power | resin (per | protection | circuit | at 60° C. for |
| | Battery | supply | thousand | circuit | inoperable | 1 month |
| | package | (Wh/l) | parts) | inoperable | (N/cm²) | (mm) |
| Ex. 1 | Aluminum | 500 | — | 123 | 5 | 0.5 |
| | can | | | | | |
| Ex. 2 | Aluminum | 500 | — | 115 | 4 | 0.4 |
| | can | | | | | |
| Ex. 3 | Aluminum | 500 | — | 104 | 3 | 0.4 |
| | laminate | | | | | |
| Ex. 4 | Aluminum | 500 | — | 98 | 2 | 0.4 |
| | laminate | | | | | |
| Ex. 5 | Aluminum | 500 | — | 85 | 1 | 0.3 |
| | laminate | | | | | |
| Ex. 6 | Aluminum | 500 | — | 85 | 1 | 0.3 |
| | laminate | | | | | |
| Ex. 7 | Aluminum | 535 | 5 | 78 | 0.5 | 0.3 |
| | laminate | | | | | |
| Ex. 8 | Aluminum | 535 | 0 | 74 | 0.3 | 0.2 |
| | laminate | | | | | |
| Ex. 9 | Aluminum | 550 | 0 | 71 | 0.2 | 0.2 |
| | laminate | | | | | |
| Ex. 10 | Polyethylene | 560 | 0 | 68 | 0.2 | 0.2 |
| | film + PET | | | | | |
| | film | | | | | |
| Ex. 11 | Clay- | 570 | 0 | 66 | 0.2 | 0.2 |
| | mineral- | | | | | |
| | based film | | | | | |
| Ex. 12 | Vacuum- | 580 | 0 | 64 | 0.2 | 0.2 |
| | deposited | | | | | |
| | polypropylene | | | | | |
| | film | | | | | |
| Com. | Aluminum | 500 | — | 140 | 11 | 1.3 |
| Ex. 1 | can | | | | | |
| Com. | Aluminum | 500 | — | 152 | 2 | 1.1 |
| Ex. 2 | laminate | | | | | |
| Com. | Aluminum | 500 | — | 161 | 15 | 1.2 |
| Ex. 3 | laminate | | | | | |
| Com. | Aluminum | 500 | — | 158 | 20 | 1.4 |
| Ex. 4 | laminate | | | | | |

### Example 1

The shape-memory resin (reaction-curable resin) used was silicone. A two-component mixture was injected into an aluminum mold at 2 kgf and was cured by heating at 120° C. for 30 minutes to form a curved power supply cover as the original shape. The power supply cover was heat-pressed at 90° C. to pressurize the center thereof, thus forming a lid-shaped flat molded part. The power supply cover had the shape shown in FIGS. 12A and 12B.

The LSM-601 strain analyzer was used to determine that the center of the molded part was strained from its polarized color. The glass transition temperature of the molded part was determined to be 60° C. by measurement using TMA/SS7100.

The power supply used was a lithium ion battery having a nickel positive electrode and an artificial graphite negative electrode and housed in an aluminum can. The lithium ion battery had a rated capacity of 1,650 mAh, an average discharging voltage of 3.6 V, a thickness of 4.95 mm, a width of 40 mm, and a length of 60 mm, from which the nominal energy density was calculated as follows:

1,650×3.6×1,000/(4.95×40×60)=500 Wh/l.

The elastic strain of the silicone at room temperature was estimated to be 10% in accordance with JIS K7113. By the same measurement at an ambient temperature of the glass transition temperature+10° C., namely, 70° C., the elastic strain at the softening temperature was estimated to be 220%. Hence, the property change ratio after heating was calculated as follows: 220%/10%=22.0.

To measure the temperature of a printed board of a liquid crystal display in a cellular phone, a K-type thermocouple was bonded to the printed board, and the maximum temperature was measured using a GL220 data logger from Graphtec Corporation. To reproduce the abnormal charging mode of the power supply, the cellular phone was placed in a constant-temperature bath at 45° C. and was supplied with a 1 C current, namely, a current of 1,650 mA, at 12 V for two and a half hours with the protection circuit of the battery short-circuited and inoperable. The maximum temperature of the printed board was determined to be 123° C. In addition, it was demonstrated that the silicone power supply cover bent with heat and came off, contributing to heat dissipation.

To measure the stress of a flexible board disposed at a hinge of a cellular phone, a strain gauge from Kyowa Electronic Instruments Co., Ltd. having a gauge length of 2 mm was bonded to both surfaces of the flexible board, and the maximum stress was measured using a GL220 data logger from Graphtec Corporation. To reproduce the abnormal charging mode of the power supply, the cellular phone was placed in a constant-temperature bath at 45° C. and was supplied with a 1 C current, namely, a current of 1,650 mA, at 12 V for two and a half hours with the protection circuit of the battery short-circuited and inoperable. The maximum stress on both surfaces of the flexible board was determined to be 5.0 (N/cm²).

To measure the expansion of a power supply of a cellular phone, the battery was fully charged to 4.2 V, and the thickness of the battery was determined to be 4.95 mm. One month after the cellular phone was placed in a constant-temperature bath at 60° C., the thickness of the expanded battery was 5.45 mm. Hence, the amount of expansion was estimated as follows: 5.45−4.95=0.5 mm.

### Example 2

The shape-memory resin (reaction-curable resin) used was epoxy. A two-component mixture was injected into an aluminum mold at 2 kgf and was cured by heating at 110° C. for 20 minutes to form a compressed hinge pin (rotating shaft) as the original shape. The hinge pin was heated again at 90° C. and was cooled to form a hinge pin expanded with respect to its original shape. The glass transition temperature of the hinge pin was determined to be 140° C. by measurement using TMA/SS7100. By the same measurement as in Example 1, the nominal energy density was determined to be 500 Wh/l.

The elastic strain of the epoxy at room temperature was estimated to be 5% in accordance with JIS K7113. By the same measurement at an ambient temperature of the glass transition temperature+10° C., namely, 150° C., the elastic strain at the softening temperature was estimated to be 60%. Hence, the property change ratio after heating was calculated as follows: 60%/5%=12.0.

By the same measurement as in Example 1, the maximum temperature of the printed board was determined to be 115° C. In addition, it was demonstrated that the epoxy hinge pin contracted and lost its hinge function. By the same measurement as in Example 1, the maximum stress on both surfaces of the flexible board was determined to be 4.0 (N/cm²).

To measure the expansion of a power supply of a cellular phone, the battery was fully charged to 4.2 V, and the thickness of the battery was determined to be 4.95 mm. One month after the cellular phone was placed in a constant-temperature bath at 60° C., the thickness of the expanded battery was 5.35 mm. Hence, the amount of expansion was estimated as follows: 5.35−4.95=0.4 mm.

### Example 3

The shape-memory resin (reaction-curable resin) used was urethane. A two-component mixture was injected into an aluminum mold at 2 kgf and was cured by heating at 100° C. for 20 minutes to form a battery group casing having a protrusion as the original shape. The battery group casing was heat-pressed at 90° C. to form a battery group casing having its protrusion compressed. The glass transition temperature of the battery group casing was determined to be 77° C. by measurement using TMA/SS7100. By the same measurement as in Example 1, the nominal energy density was determined to be 500 Wh/l.

The elastic strain of the urethane at room temperature was estimated to be 15% in accordance with JIS K7113. By the same measurement at an ambient temperature of the glass transition temperature+10° C., namely, 87° C., the elastic strain at the softening temperature was estimated to be 180%. Hence, the property change ratio after heating was calculated as follows: 180%/15%=12.0.

By the same measurement as in Example 1, the maximum temperature of the printed board was determined to be 104° C. In addition, it was demonstrated that the protrusion of the urethane battery group casing extended. By the same measurement as in Example 1, the maximum stress on both surfaces of the flexible board was determined to be 3.0 (N/cm²).

To measure the expansion of a power supply of a cellular phone, the battery was fully charged to 4.2 V, and the thickness of the battery was determined to be 4.95 mm. One month after the cellular phone was placed in a constant-temperature bath at 60° C., the thickness of the expanded battery was 5.35 mm. Hence, the amount of expansion was estimated as follows: 5.35−4.95=0.4 mm.

### Example 4

The shape-memory resin (reaction-curable resin) used was acrylic. A two-component mixture was injected into an aluminum mold at 2 kgf and was cured by heating at 90° C. for 15 minutes to form a power supply cover having a contracted catch as the original shape (the shape of the catch 74a in FIGS. 14A and 14B). The catch was heat-pressed at 90° C. to form an extended catch. The glass transition temperature of the catch was determined to be 123° C. by measurement using TMA/SS7100. By the same measurement as in Example 1, the nominal energy density was determined to be 500 Wh/l.

The elastic strain of the acrylic at room temperature was estimated to be 20% in accordance with JIS K7113. By the same measurement at an ambient temperature of the glass transition temperature+10° C., namely, 133° C., the elastic strain at the softening temperature was estimated to be 260%. Hence, the property change ratio after heating was calculated as follows: 260%/20%=13.0.

By the same measurement as in Example 1, the maximum temperature of the printed board was determined to be 98° C. In addition, it was demonstrated that the protrusion of the catch of the acrylic power supply cover contracted, allowing it to come off. By the same measurement as in Example 1, the maximum stress on both surfaces of the flexible board was determined to be 2.0 (N/cm²).

To measure the expansion of a power supply of a cellular phone, the battery was fully charged to 4.2 V, and the thickness of the battery was determined to be 4.95 mm. One month after the cellular phone was placed in a constant-temperature bath at 60° C., the thickness of the expanded battery was 5.45 mm. Hence, the amount of expansion was estimated as follows: 5.45−4.95=0.5 mm.

### Example 5

The shape-memory resin (reaction-curable resin) used was polyurethane. A two-component mixture was injected into an aluminum mold at 2 kgf and was cured by heating at 85° C. for 10 minutes to form a fitting portion for a folding portion to fit into as the original shape (the shape of the fitting portion 84 in FIGS. 16A and 16B). The fitting portion was heated at 90° C. and was then cooled to form a contracted fitting portion. The glass transition temperature of the fitting portion was determined to be 80° C. by measurement using TMA/SS7100. By the same measurement as in Example 1, the nominal energy density was determined to be 500 Wh/l.

The elastic strain of the urethane resin at room temperature was estimated to be 12% in accordance with JIS K7113. By the same measurement at an ambient temperature of the glass transition temperature+10° C., namely, 90° C., the elastic strain at the softening temperature was estimated to be 120%. Hence, the property change ratio after heating was calculated as follows: 120%/12%=10.0.

By the same measurement as in Example 1, the maximum temperature of the printed board was determined to be 85° C. In addition, it was demonstrated that the polyurethane fitting portion extended and released the folding portion. By the same measurement as in Example 1, the maximum stress on both surfaces of the flexible board was determined to be 1.0 (N/cm²).

To measure the expansion of a power supply of a cellular phone, the battery was fully charged to 4.2 V, and the thickness of the battery was determined to be 4.95 mm. One month after the cellular phone was placed in a constant-temperature bath at 60° C., the thickness of the expanded battery was 5.25 mm. Hence, the amount of expansion was estimated as follows: 5.25−4.95=0.3 mm.

### Example 6

The shape-memory resin (reaction-curable resin) used was epoxy. A two-component mixture was injected into an aluminum mold at 2 kgf and was cured by heating at 79° C. for 9 minutes to form an operating button as the original shape (the shape of the molded part 92 in FIGS. 17A and 17B). The operating button was heated at 90° C. to form a deformed operating button. The glass transition temperature of the operating button was determined to be 80° C. by measurement using TMA/SS7100. By the same measurement as in Example 1, the nominal energy density was determined to be 500 Wh/l.

The elastic strain of the epoxy at room temperature was estimated to be 10% in accordance with JIS K7113. By the same measurement at an ambient temperature of the glass transition temperature+10° C., namely, 90° C., the elastic strain at the softening temperature was estimated to be 80%. Hence, the property change ratio after heating was calculated as follows: 80%/10%=8.0.

By the same measurement as in Example 1, the maximum temperature of the printed board was determined to be 85° C. In addition, it was demonstrated that the epoxy operating button returned to its original shape, allowing switching operation. By the same measurement as in Example 1, the maximum stress on both surfaces of the flexible board was determined to be 1.0 (N/cm²).

To measure the expansion of a power supply of a cellular phone, the battery was fully charged to 4.2 V, and the thickness of the battery was determined to be 4.95 mm. One month after the cellular phone was placed in a constant-temperature bath at 60° C., the thickness of the expanded battery was 5.25 mm. Hence, the amount of expansion was estimated as follows: 5.25−4.95=0.3 mm.

### Example 7

The shape-memory resin (reaction-curable resin) used was polyurethane. A two-component mixture was injected into an aluminum mold at 2 kgf and was cured by heating at 80° C. for 10 minutes to form a battery pack casing having a protrusion (framed structure) as the original shape. The packaging material used for the battery was an aluminum laminate. The protrusion was heat-pressed at 90° C. to form a battery pack casing having a flat surface. The glass transition temperature was determined to be 120° C. by measurement using TMA/SS7100. The nominal energy density was determined to be 535 Wh/l.

The elastic strain of the polyurethane at room temperature was estimated to be 20% in accordance with JIS K7113. By the same measurement at an ambient temperature of the glass transition temperature+10° C., namely, 130° C., the elastic strain at the softening temperature was estimated to be 22%. Hence, the property change ratio after heating was calculated as follows: 22%/20%=1.1.

By the same measurement as in Example 1, the maximum temperature of the printed board was determined to be 78° C. In addition, it was demonstrated that the battery pack casing returned to its original shape, having the protrusion formed thereon. By the same measurement as in Example 1, the maximum stress on both surfaces of the flexible board was determined to be 0.5 (N/cm²).

To measure the expansion of a power supply of a cellular phone, the battery was fully charged to 4.2 V, and the thickness of the battery was determined to be 4.95 mm. One month after the cellular phone was placed in a constant-temperature bath at 60° C., the thickness of the expanded battery was 5.25 mm. Hence, the amount of expansion was estimated as follows: 5.25−4.95=0.3 mm. The number of covering defects per thousand parts after the injection of the shape-memory resin was five.

### Example 8

The shape-memory resin (reaction-curable resin) used was polyurethane. A two-component mixture was injected into an aluminum mold at 2 kgf and was cured by heating at 80° C. for 5 minutes to form a battery pack casing having a protrusion (framed structure) as the original shape. The packaging material used for the battery was an aluminum laminate. The protrusion was formed by cutting a bubble portion for removing bubbles. The protrusion was heat-pressed at 90° C. to form a battery pack casing having a flat surface. The glass transition temperature was determined to be 85° C. by measurement using TMA/SS7100. The nominal energy density was determined to be 535 Wh/l.

The elastic strain of the polyurethane at room temperature was estimated to be 10% in accordance with JIS K7113. By the same measurement at an ambient temperature of the glass transition temperature+10° C., namely, 95° C., the elastic strain at the softening temperature was estimated to be 20%. Hence, the property change ratio after heating was calculated as follows: 20%/10%=2.0.

By the same measurement as in Example 1, the maximum temperature of the printed board was determined to be 74° C. In addition, it was demonstrated that the battery pack casing returned to its original shape, having the protrusion formed thereon. By the same measurement as in Example 1, the maximum stress on both surfaces of the flexible board was determined to be 0.3 (N/cm²).

To measure the expansion of a power supply of a cellular phone, the battery was fully charged to 4.2 V, and the thickness of the battery was determined to be 4.95 mm. One month after the cellular phone was placed in a constant-temperature bath at 60° C., the thickness of the expanded battery was 5.15 mm. Hence, the amount of expansion was estimated as follows: 5.15−4.95=0.2 mm. The number of covering defects after the injection of the shape-memory resin was zero.

### Example 9

The shape-memory resin (reaction-curable resin) used was polyurethane. A two-component mixture was injected into an aluminum mold at 2 kgf and was cured by heating at 80° C. for 3 minutes to form a battery pack casing having a protrusion (frameless structure) as the original shape. The packaging material used for the battery was an aluminum laminate. The protrusion was heat-pressed at 90° C. to form a battery pack casing having a flat surface. The glass transition temperature was determined to be 90° C. by measurement using TMA/SS7100. The nominal energy density was determined to be 550 Wh/l.

The elastic strain of the polyurethane at room temperature was estimated to be 8% in accordance with JIS K7113. By the same measurement at an ambient temperature of the glass transition temperature+10° C., namely, 100° C., the elastic strain at the softening temperature was estimated to be 48%. Hence, the property change ratio after heating was calculated as follows: 48%/8%=6.0.

By the same measurement as in Example 1, the maximum temperature of the printed board was determined to be 71° C. In addition, it was demonstrated that the battery pack casing returned to its original shape, having the protrusion formed thereon. By the same measurement as in Example 1, the maximum stress on both surfaces of the flexible board was determined to be 0.2 (N/cm²).

To measure the expansion of a power supply of a cellular phone, the battery was fully charged to 4.2 V, and the thickness of the battery was determined to be 4.95 mm. One month after the cellular phone was placed in a constant-temperature bath at 60° C., the thickness of the expanded battery was 5.15 mm. Hence, the amount of expansion was estimated as follows: 5.15−4.95=0.2 mm. The number of covering defects after the injection of the shape-memory resin was zero.

### Example 10

The shape-memory resin (reaction-curable resin) used was polyurethane. A two-component mixture was injected into an aluminum mold at 2 kgf and was cured by heating at 80° C. for 3 minutes to form a battery pack casing having a protrusion (frameless structure) as the original shape. The packaging material used for the battery was a double-layer film composed of a polyethylene film and a PET film. The protrusion was heat-pressed at 90° C. to form a battery pack casing having a flat surface. The glass transition temperature was determined to be 100° C. by measurement using TMA/SS7100. The nominal energy density was determined to be 560 Wh/l.

The elastic strain of the polyurethane at room temperature was estimated to be 10% in accordance with JIS K7113. By the same measurement at an ambient temperature of the glass transition temperature+10° C., namely, 110° C., the elastic strain at the softening temperature was estimated to be 50%. Hence, the property change ratio after heating was calculated as follows: 50%/10%=5.0.

By the same measurement as in Example 1, the maximum temperature of the printed board was determined to be 68° C. In addition, it was demonstrated that the battery pack casing returned to its original shape, having the protrusion formed thereon. By the same measurement as in Example 1, the maximum stress on both surfaces of the flexible board was determined to be 0.2 (N/cm²).

To measure the expansion of a power supply of a cellular phone, the battery was fully charged to 4.2 V, and the thickness of the battery was determined to be 4.95 mm. One month after the cellular phone was placed in a constant-temperature bath at 60° C., the thickness of the expanded battery was 5.15 mm. Hence, the amount of expansion was estimated as follows: 5.15−4.95=0.2 mm. The number of covering defects after the injection of the shape-memory resin was zero.

### Example 11

The shape-memory resin (reaction-curable resin) used was polyurethane. A two-component mixture was injected into an aluminum mold at 2 kgf and was cured by heating at 80° C. for 3 minutes to form a battery pack casing having a protrusion (frameless structure) as the original shape. The packaging material used for the battery was a clay-mineral-based film. The protrusion was heat-pressed at 90° C. to form a battery pack casing having a flat surface. The glass transition temperature was determined to be 105° C. by measurement using TMA/SS7100. The nominal energy density was determined to be 570 Wh/l.

The elastic strain of the polyurethane at room temperature was estimated to be 10% in accordance with JIS K7113. By the same measurement at an ambient temperature of the glass transition temperature+10° C., namely, 115° C., the elastic strain at the softening temperature was estimated to be 50%. Hence, the property change ratio after heating was calculated as follows: 50%/10%=5.0.

By the same measurement as in Example 1, the maximum temperature of the printed board was determined to be 66° C. In addition, it was demonstrated that the battery pack casing returned to its original shape, having the protrusion formed thereon. By the same measurement as in Example 1, the maximum stress on both surfaces of the flexible board was determined to be 0.2 (N/cm²).

To measure the expansion of a power supply of a cellular phone, the battery was fully charged to 4.2 V, and the thickness of the battery was determined to be 4.95 mm. One month after the cellular phone was placed in a constant-temperature bath at 60° C., the thickness of the expanded battery was 5.15 mm. Hence, the amount of expansion was estimated as follows: 5.15−4.95=0.2 mm. The number of covering defects after the injection of the shape-memory resin was zero.

### Example 12

The shape-memory resin (reaction-curable resin) used was polyurethane. A two-component mixture was injected into an aluminum mold at 2 kgf and was cured by heating at 80° C. for 3 minutes to form a battery pack casing having a protrusion (frameless structure) as the original shape. The packaging material used for the battery was a vacuum-deposited polypropylene film. The protrusion was heat-pressed at 90° C. to form a battery pack casing having a flat surface. The glass transition temperature was determined to be 110° C. by measurement using TMA/SS7100. The nominal energy density was determined to be 580 Wh/l.

The elastic strain of the polyurethane at room temperature was estimated to be 10% in accordance with JIS K7113. By the same measurement at an ambient temperature of the glass transition temperature+10° C., namely, 120° C., the elastic strain at the softening temperature was estimated to be 50%. Hence, the property change ratio after heating was calculated as follows: 50%/10%=5.0.

By the same measurement as in Example 1, the maximum temperature of the printed board was determined to be 64° C. In addition, it was demonstrated that the battery pack casing returned to its original shape, having the protrusion formed thereon. By the same measurement as in Example 1, the maximum stress on both surfaces of the flexible board was determined to be 0.2 (N/cm²).

To measure the expansion of a power supply of a cellular phone, the battery was fully charged to 4.2 V, and the thickness of the battery was determined to be 4.95 mm. One month after the cellular phone was placed in a constant-temperature bath at 60° C., the thickness of the expanded battery was 5.15 mm. Hence, the amount of expansion was estimated as follows: 5.15−4.95=0.2 mm. The number of covering defects after the injection of the shape-memory resin was zero.

### Comparative Example 1

The shape-memory resin (reaction-curable resin) used was silicone. A two-component mixture was injected into an aluminum mold at 2 kgf and was cured by heating at 120° C. for 20 minutes to form a power supply cover. The glass transition temperature was determined to be −20° C. by measurement using TMA/SS7100. The nominal energy density was determined to be 500 Wh/l.

The elastic strain of the silicone at room temperature was estimated to be 10% in accordance with JIS K7113. By the same measurement at an ambient temperature of the glass transition temperature+10° C., namely, −10° C., the elastic strain at the softening temperature was estimated to be 10.08%. Hence, the property change ratio after heating was calculated as follows: 10.08%/10%=1.08.

By the same measurement as in Example 1, the maximum temperature of the printed board was determined to be 140° C. By the same measurement as in Example 1, the maximum stress on both surfaces of the flexible board was determined to be 11.0 (N/cm²).

To measure the expansion of a power supply of a cellular phone, the battery was fully charged to 4.2 V, and the thickness of the battery was determined to be 4.95 mm. One month after the cellular phone was placed in a constant-temperature bath at 60° C., the thickness of the expanded battery was 6.25 mm. Hence, the amount of expansion was estimated as follows: 6.25−4.95=1.3 mm.

### Comparative Example 2

The shape-memory resin (reaction-curable resin) used was epoxy. A two-component mixture was injected into an aluminum mold at 2 kgf and was left standing at room temperature for one day to form a power supply cover. The glass transition temperature was determined to be 155° C. by measurement using TMA/SS7100. The nominal energy density was determined to be 500 Wh/l.

The elastic strain of the epoxy at room temperature was estimated to be 10% in accordance with JIS K7113. By the same measurement at an ambient temperature of the glass transition temperature+10° C., namely, 165° C., the elastic strain at the softening temperature was estimated to be 10.05%. Hence, the property change ratio after heating was calculated as follows: 10.05%/10%=1.05.

By the same measurement as in Example 1, the maximum temperature of the printed board was determined to be 152° C. By the same measurement as in Example 1, the maximum stress on both surfaces of the flexible board was determined to be 12.0 (N/cm²).

To measure the expansion of a power supply of a cellular phone, the battery was fully charged to 4.2 V, and the thickness of the battery was determined to be 4.95 mm. One month after the cellular phone was placed in a constant-temperature bath at 60° C., the thickness of the expanded battery was 6.05 mm. Hence, the amount of expansion was estimated as follows: 6.05−4.95=1.1 mm.

### Comparative Example 3

The shape-memory resin (reaction-curable resin) used was thermoplastic polycarbonate. After being melted at 200° C., the resin was extruded and cured in 20 seconds to form a power supply cover. The glass transition temperature was determined to be 120° C. by measurement using TMA/SS7100. The nominal energy density was determined to be 500 Wh/l.

The elastic strain of the thermoplastic polycarbonate at room temperature was estimated to be 15% in accordance with JIS K7113. By the same measurement at an ambient temperature of the glass transition temperature+10° C., namely, 130° C., the elastic strain at the softening temperature was estimated to be 1,815%. Hence, the property change ratio after heating was calculated as follows: 1,815%/15%=121.0.

By the same measurement as in Example 1, the maximum temperature of the printed board was determined to be 161° C. By the same measurement as in Example 1, the maximum stress on both surfaces of the flexible board was determined to be 15.0 (N/cm²).

To measure the expansion of a power supply of a cellular phone, the battery was fully charged to 4.2 V, and the thickness of the battery was determined to be 4.95 mm. One month after the cellular phone was placed in a constant-temperature bath at 60° C., the thickness of the expanded battery was 6.15 mm. Hence, the amount of expansion was estimated as follows: 6.15−4.95=1.2 mm.

### Comparative Example 4

The shape-memory resin (reaction-curable resin) used was thermoplastic polypropylene. After being melted at 200° C., the resin was extruded and cured in 30 seconds to form a power supply cover. The glass transition temperature was determined to be 50° C. by measurement using TMA/SS7100. The nominal energy density was determined to be 500 Wh/l.

The elastic strain of the thermoplastic polypropylene at room temperature was estimated to be 20% in accordance with JIS K7113. By the same measurement at an ambient temperature of the glass transition temperature+10° C., namely, 60° C., the elastic strain at the softening temperature was estimated to be 2,100%. Hence, the property change ratio after heating was calculated as follows: 2,100%/20%=105.0.

By the same measurement as in Example 1, the maximum temperature of the printed board was determined to be 158° C. By the same measurement as in Example 1, the maximum stress on both surfaces of the flexible board was determined to be 20.0 (N/cm²).

To measure the expansion of a power supply of a cellular phone, the battery was fully charged to 4.2 V, and the thickness of the battery was determined to be 4.95 mm. One month after the cellular phone was placed in a constant-temperature bath at 60° C., the thickness of the expanded battery was 6.35 mm. Hence, the amount of expansion was estimated as follows: 6.35−4.95=1.4 mm.

The results obtained from Examples 1 to 12 and Comparative Examples 1 to 4 above suggest, for example, the following. The glass transition temperature of the reaction-curable resin is preferably 60° C. to 140° C. A glass transition temperature of −20° C., as in Comparative Example 1, or 155° C., as in Comparative Example 2, increases the maximum temperature of the printed board and also increases its stress and expansion.

In addition, the use of a thermoplastic resin, as in Comparative Examples 3 and 4, is undesirable. The use of a thermoplastic resin increases the maximum temperature of the printed board and also increases its stress and expansion.

For applications of the techniques according to the embodiments to battery pack casings, for example, as demonstrated in Examples 7 to 12, the glass transition temperature of the reaction-curable resin is preferably 80° C. to 120° C. In addition, the conditions specified in Examples 10 to 12 are more preferable in view of nominal energy density and the number of covering defects.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A battery pack comprising:
a battery; and
a casing covering the battery and comprising a shape-memory resin, a portion or the entirety of the casing being deformed by heating at a predetermined temperature, the portion or the entirety of the deformed casing returning to an original shape at the predetermined temperature or higher.

2. The battery pack according to claim 1, wherein the casing returns to the original shape such that a portion of the casing forms a protrusion.

3. The battery pack according to claim 1, wherein the predetermined temperature is near the glass transition temperature of the casing, the glass transition temperature being 60° C. to 140° C.

4. The battery pack according to claim 1, wherein the predetermined temperature exceeds the temperature of the battery pack in normal use.

5. A method for manufacturing a battery pack, comprising:
positioning a battery using a positioning portion;
filling a space around the positioned battery with a shape-memory resin so as to form at least one protrusion; and
deforming the protrusion by applying an external force to the protrusion in a heated state.

6. The method for manufacturing a battery pack according to claim 5, wherein the protrusion is formed around the positioning portion.

7. The method for manufacturing a battery pack according to claim 5, wherein the glass transition temperature of the shape-memory resin is 60° C. to 140° C.

8. An electronic device comprising:
a power supply; and
at least one molded part comprising a shape-memory resin, a portion or the entirety of the molded part being deformed by heating at a predetermined temperature, the portion or the entirety of the molded part returning to an original shape at the predetermined temperature or higher.

9. The electronic device according to claim 8, wherein the molded part is a power supply lid covering the power supply, the power supply lid being opened as the molded part returns to the original shape, thereby releasing the power supply from the electronic device.

10. The electronic device according to claim 8, wherein the molded part is a portion or the entirety of a switch mechanism, the switch mechanism being inoperable after the molded part returns to the original shape.

11. The electronic device according to claim 8, further comprising:
a cooling unit configured to cool the power supply; and
a switch mechanism configured to start the cooling unit, the switch mechanism including the molded part, the switch mechanism operating to start the cooling unit after the molded part returns to the original shape.

12. The electronic device according to claim 8, wherein the predetermined temperature is near the glass transition temperature of the shape-memory resin, the glass transition temperature being 60° C. to 140° C.

13. The electronic device according to claim 8, wherein the predetermined temperature exceeds the temperature of the power supply in normal use.

14. A molded part comprising a shape-memory resin, the molded part being deformed by heating at a predetermined temperature, the deformed molded part being disposed near a power supply, the molded part returning to an original shape at the predetermined temperature or higher.
